(19) United States
(12) Patent Application Publication
(10) Pub. No.: US 2025/0040560 A1
(43) Pub. Date: Feb. 6, 2025

(54) NON-DAIRY MILK

(71) Applicant: Atomo Coffee, Inc., Seattle, WA (US)

(72) Inventors: Charles M. SHAW, Seattle, WA (US); Jarret STOPFORTH, Seattle, WA (US); Trevor NIEKOWAL, Seattle, WA (US)

(21) Appl. No.: 18/576,727

(22) PCT Filed: Jul. 8, 2022
(86) PCT No.: PCT/US2022/036539

§ 371 Date: Jan. 5, 2024

Related U.S. Application Data
(60) Provisional application No. 63/219,740, filed on Jul. 8, 2021.

(51) Int. Cl. A23C 11/10; A23C 20/02; A23F 5/40; A23G 9/42; A23L 7/104

(52) U.S. Cl. CPC A23C 11/103; A23C 20/025; A23F 5/40; A23G 9/42; A23L 7/107

(57) ABSTRACT

Provided are methods for producing particle compositions for replicating the texture of dairy milk or of derivates thereof, comprising contacting a plant-based base material comprising protein(s) and carbohydrate(s) with a β-glucanase and/or a deamidase, under conditions sufficient to provide particles having a particle size distribution (PSD) in the range of 0.1 μm to 10 μm, or any subrange thereof, including e.g., 0.1 μm to 5 μm). Also provided are non-dairy food or beverage compositions (e.g., plant-based: milk, half-and-half, cream, heavy cream, fermented product (e.g., yogurt, kefir, etc.), milk powder, whey, cheese, etc.). produced using the methods and the provided particle compositions, and hybrid dairy/non-dairy food or beverage compositions comprising one or more of the provided plant-based particle compositions.

### FIELD OF THE INVENTION

Aspects of the invention generally relate to dairy and non-dairy compositions and methods for making same, more particularly to methods for making plant-based dairy analog compositions that replicate the texture and/or microstructural quality of dairy milk in various forms and show resilience against heat-induced structure change/loss, and even more particularly to methods comprising enzymatic processing for making the plant-based dairy analog compositions. Further aspects provide mixtures of dairy and non-dairy compositions.

### BACKGROUND

There are several properties (e.g., flavor, texture, nutrition and functionality) of dairy milk that non-dairy milks and derivatives thereof (e.g., non-dairy creamers, non-dairy yogurt, etc.) must match or closely approximate to fully or effectively substitute for milk in many applications.

Dairy milk is a dispersion primarily composed of a continuous aqueous phase comprising various solutes, and a dispersed phase of milk/butterfat having a relatively small particle size of generally <5 μm (e.g., after homogenization). In combination, the slightly thickened aqueous phase containing modest amounts of solutes, and the well-controlled particle size distribution (PSD), give milk its characteristic texture.

The particle size is particularly crucial for achieving the correct texture in dairy and in non-dairy analogs. Aside from the composition of the particles per se, perception of the milk-whether dairy based or otherwise-changes dramatically over a relatively small range of dispersed particle sizes (Singer, N. S. & J. M. Dunn, J. M., “Protein Microparticulation: The Principle and the Process,” Journal of the American College of Nutrition, Vol. 9 No. 4, 388-397 (1990); DOI: 10.1080/07315724.1990.10720397). When the dispersed particles are in the 0.1-3 μm range, the perception of the product is ideal; that is, creamy. As particles coarsen relative to this ideal range, the texture correspondingly degrades, and as the particle size rises to 5 μm, the milk is perceived as chalky or powdery. Further coarsening, for example to 8 μm or larger, shifts the perception to gritty. Particle sizes smaller than about 0.1 μm are too small, providing a texture perceived as thickened yet empty, lacking the creaminess produced by larger particle sizes.

The texture of dairy milk can be difficult to replicate using plant-derived analogs. Achieving desired particle size distributions by filtering, for example, can be problematic when processing large volumes in industrial production environments. While advancements in filtration technology have eased this difficulty, filter screens tend to clog readily when screening particle sizes below about 5 μm (or even below about 10 μm), requiring costly, technically sophisticated high pressure and/or large surface area filtration systems to successfully produce meaningful volumes of filtered plant milk.

Plant milks, like dairy, are composed of a dispersion, but where the dispersed particle phase is not always an endogenous fat. Instead, the dispersed particles of a plant milk are generally some combination of finely ground plant material (e.g., fine almond grounds in the case of almond milk) and/or an emulsified oil (endogenous or exogenous). Most physical/mechanical grinding equipment struggles to reduce solid plant material to sizes below 10 μm, let alone less than 5 μm. The larger material is typically filtered at some difficulty and discarded, producing another source of waste in the food system and perhaps, such as is the case with most cereal-based milks, requiring additional inputs (e.g., oils extracted from other plants) into the retained fractions. The industry has tended to focus on achieving this goal by such direct means: grind finer, filter smaller and add back new ingredients to replace what was taken away.

Thus, improved methods that reduce the size of native plant material below, for example, the 5 μm threshold are needed, particularly in the production of plant-based milks. Furthermore, methods that achieve this while reducing waste and utilizing previously undesirable materials would be particularly advantageous.

An additional challenge with producing plant-based milks is the limited heat stability of their proteins. Terrestrial plants are not typically exposed to, and thus are not required to endure, temperatures greater than 120° C. for survival. The ability of constituent plant proteins to retain their native structure and not denature and/or coagulate at conventional thermal processing temperatures is, therefore, neither assured nor predictable, and rather it is typically by chance that the native protein structure is sufficiently thermally stable for particular purposes/applications.

Thus, methods to enhance the thermal stability of plant-based protein are needed, particularly in the production of plant-based milks, and mixtures comprising same, including mixtures with dairy components and/or derivatives thereof.

### SUMMARY OF EXEMPLARY EMBODIMENTS OF THE INVENTION

Embodiments of the disclosure can be described in view of the following clauses:

1. A method for producing particles in a composition that replicate the texture of dairy milk or of a derivate thereof, comprising: contacting, under suitable solution reaction conditions, a plant-based base material having protein(s) and carbohydrate(s) with a β-glucanase (e.g., Ultimase BWL-40™ from Novozymes, etc.) and/or a deamidase (e.g., Amano PG500™; Acrylaway® or Acrylaway® HighT from Novozymes, etc.), in an amount and for a time-period sufficient to provide particles having a particle size distribution (PSD) in the range of 0.1 μm to 10 μm, provided that in the case of contacting with the β-glucanase, with or without the deamidase, particles are neither ground to 10 μm or less nor filtered through a 10 μm or less filter in achieving the PSD, and provided that in the case of contacting with the deamidase, with or without the β-glucanase, the thermal stability of the provided particles having the PSD is enhanced.

2. The method of clause 1, wherein contacting is sufficient to provide particles having a particle size distribution (PSD) in the range of 0.1 μm to 10 μm, provided that in the case of contacting with the β-glucanase, with or without the deamidase, particles are neither ground to 5 μm or less nor filtered through a 5 μm or less filter in achieving the PSD, and provided that in the case of contacting with the deamidase, with or without the β-glucanase, the thermal stability of the provided particles having the PSD is enhanced.

3. The method of clause 1, wherein contacting is sufficient to provide particles having a particle size distribution (PSD) in the range of 0.1 μm to 5 μm, provided that in the case of contacting with the β-glucanase, with or without the deamidase, particles are neither ground to 10 μm or less nor filtered through a 10 μm or less filter in achieving the PSD, and provided that in the case of contacting with the deamidase, with or without the β-glucanase, the thermal stability of the provided particles having the PSD is enhanced.

4. The method of clause 1, wherein contacting is sufficient to provide particles having a particle size distribution (PSD) in the range of 0.1 μm to 5 μm, provided that in the case of contacting with the β-glucanase, with or without the deamidase, particles are neither ground to 5 μm or less nor filtered through a 5 μm or less filter in achieving the PSD, and provided that in the case of contacting with the deamidase, with or without the β-glucanase, the thermal stability of the provided particles having the PSD is enhanced.

5. The method of any one of clauses 1-4, wherein the PSD of the provided particles is in the range of 0.1 to less than 5 μm, 0.1 μm to 4 μm, 0.1 μm to 3 μm, 1.0 μm to less than 5 μm, 1.0 μm to 4 μm, or 1.0 μm to 3 μm.

6. The method of clause 5, wherein the PSD of the provided particles is in the range of 1.0 μm to 3 μm.

7. The method of any one of clauses 1-6, wherein the provided particles having the PSD comprise β-glucanase cleavage products and/or deamidase cleavage products, and/or particles not having β-glucanase cleavage products and/or not having deamidase cleavage products, but which are released or otherwise rendered soluble by β-glucanase-mediated cleavage and/or by deamidase-mediated cleavage of another component(s) of the base material.

8. The method of any one of clauses 1-7, wherein the provided particles having the PSD comprise protein, and/or carbohydrate, and/or lipid material.

9. The method of clause 8, wherein the lipid comprises one or more of fatty acids, glycerolipids, glycerophospholipids, sphingolipids, saccharolipids, polyketides, sterol lipids, prenol lipids, waxes, oils, oil storage bodies, sterols, fats, fat-soluble vitamins (e.g., A, D, E, and K), monoglycerides, diglycerides, triglycerides, and/or phospholipids.

10. The method of any one of clauses 1-9, wherein contacting comprises contacting the base material with both the β-glucanase and the deamidase, either sequentially or at least in part contemporaneously.

11. The method of any one of clauses 1-9, wherein contacting comprises contacting with the deamidase, but not the β-glucanase.

12. The method of any one of clauses 1-11, wherein contacting with the β-glucanase, comprises contacting with about 0.01 to about 1000 units/g base material, with about 0.025 to about 50 units/g base material, with about 0.05 to about 50 units/g base material, with about 0.05 to about 10 units/g base material, or with about 0.1 to about 10 units/g base material; and/or wherein contacting with the deamidase(s) comprises contacting in an amount and for a time-period sufficient to deamidate amino acid side chains of protein(s) of the base material, and/or of the β-glucanase-treated base material, and or of the provided particles, to modify (preferably enhance) thermal stability thereof, relative to non-deamidated forms of the plant proteins, and provide a thermally stabilized texture.

13. The method of clause 12, wherein enhancing the thermal stability comprises increasing one or more of the denaturation onset temperature, the coagulation peak temperature, and/or the denaturation midpoint temperature, in each case by a value in the range of 5 to 75° C., 10 to 70° C., 15 to 65° C., 20 to 60° C., 30 to 55° C., 35 to 50° C., or in any subrange within 5 to 75° C.

14. The method of any one of clauses 1-13, wherein, when contacting with the deamidase, the deamidase comprises glutamine deamidase and/or asparagine deamidase.

15. The method of clause 14, wherein contacting with the deamidase comprises: contacting with glutamine deamidase at about 0.01 to about 1000 units/g base material, at about 0.05 to about 75 units/g base material, or at: about 0.1 to about 15 units/g base material; and/or comprises contacting with asparagine deamidase at about 0.01 to about 1000 units/g base material, at about 0.05 to about 100 units/g base material, or at about 0.1 to about 30 units/g base material.

16. The method of any one of clauses 1-9, wherein contacting comprises contacting with the β-glucanase, but not the deamidase, preferably wherein contacting with the β-glucanase, comprises contacting with about 0.01 to about 1000 units/g base material, with about 0.025 to about 50 units/g base material, with about 0.05 to about 50 units/g base material, with about 0.05 to about 10 units/g base material, or with about 0.1 to about 10 units/g base material.

17. The method of any one of clauses 1-16, further comprising, after the contacting with the β-glucanase and/or the deamidase, centrifuging the solution to provide an aqueous supernatant phase (whey) containing soluble and dispersed proteins, and optionally subjecting the supernatant phase to microparticulation to provide a plant-based non-dairy microparticulated whey.

18. The method of any one of clauses 1-16, further comprising one or more of washing or otherwise cleaning, blanching, parboiling, boiling, drying, grinding, denaturing, coagulating, sedimenting, centrifuging, concentrating, filtering, and/or microparticulating the base material, either prior to, during, or after the contacting with the β-glucanase and/or with the deamidase.

19. The method of clause 18, comprising centrifuging, or otherwise concentrating the provided particles having the PSD to provide an isolated particle concentrate suitable for use as a particle additive.

20. The method of clause 19, comprising use of the particle concentrate as, or as an additive for producing, a non-dairy plant-based milk, whey, half-and-half, cream, heavy cream, fermented product (e.g., yogurt, kefir, etc.), cheese, or powder; or use of the particle concentrate as an additive for producing a hybrid dairy, plant-based whey, milk, half-and-half, cream, heavy cream, fermented product (e.g., yogurt, kefir, etc.), cheese, or powder.

21. The method of clause 18, wherein drying the base material comprises adjusting the a_{w} comprises adjusting to a value less than or equal to a value selected from the group consisting of 0.95, 0.90, 0.85. 0.80, 0.75, 0.70, 0.65, 0.6, 0.55, 0.5, 0.45, 0.4, 0.35, 0.3, 0.25, 0.2, 0.15 and 0.1, or less than or equal to a value in a range of 0.10 to 0.95, including adjusting to a value less than or equal to any value in any subranges therein (e.g., 0.20 to 0.85, 0.25 to 0.80, 0.25 to 0.75, 0.25 to 0.70, 0.25 to 0.65, 0.25 to 0.60, 0.25 to 0.55), preferably to a value in a range of 0.25 to 0.70.

22. The methods of any one of clauses 1-21, wherein plant-based base material comprises or is a natural and/or a processed and/or restructured plant material.

23. The method of any one of clauses 1-22, wherein the plant-based material comprises one or more of: oil seeds; nuts; legumes; and/or grains.

24. The method of clause 23, wherein; the oil seeds comprise one or more of pumpkin seeds, sunflower seeds, watermelon seeds, flax, and/or hemp; the nuts comprise one or more of almonds, walnuts, cashews, macadamia, and/or hazelnuts; the legumes comprise one or more of peanuts, and/or peas; and the grains comprise one or more of wheat, oat, corn, rye, sorghum, rice, barley, millet, fonio, amaranth, quinoa, and or buckwheat.

25. The method of clause 24, wherein the oil seeds comprise pumpkin seeds.

26. A food or beverage component, comprising a PSD component prepared by the method of any one of clauses 1-25.

27. The food or beverage component of clause 26, comprising or being a plant-based milk, plant-based milk, plant-based half-and-half, plant-based cream, plant-based heavy cream, plant-based fermented product (e.g., yogurt, kefir, etc.), plant-based milk powder, plant-based whey, or plant-based cheese.

28. The food or beverage component of clause 27, comprising a combination of a dairy milk or component or derivative thereof with the plant-based milk, with the plant-based milk, plant-based half-and-half, plant-based cream, plant-based heavy cream, plant-based fermented product (e.g., yogurt, kefir, etc.), plant-based milk powder, plant-based whey, or plant-based cheese.

29. A method for preparing a plant-based milk analog from a plant base material, comprising: grinding a plant-based base material, wet or dry, to provide a PSD of less than 1 mm; coagulating low heat stability proteins from an aqueous mixture of the ground base material; filtering the coagulated mixture to remove the coagulated protein; and treating the filtrate with a β-glucanase (e.g., Ultimase BWL-40™ from Novozymes, etc.) and/or a deamidase (e.g., Amano PG500™; Acrylaway® or Acrylaway® HighT from Novozymes, etc.), in an amount and for a time-period sufficient to provide particles having a particle size distribution (PSD) in the range of 0.1 μm to 10 μm, provided that in the case of contacting with the β-glucanase, with or without the deamidase, particles are neither ground to 10 μm or less nor filtered through a 10 μm or less filter in achieving the PSD, and provided that in the case of contacting with the deamidase, with or without the β-glucanase, the thermal stability of the provided particles having the PSD is enhanced.

30. The method of clause 29, wherein contacting is sufficient to provide particles having a particle size distribution (PSD) in the range of 0.1 μm to 10 μm, provided that in the case of contacting with the β-glucanase, with or without the deamidase, particles are neither ground to 5 μm or less nor filtered through a 5 μm or less filter in achieving the PSD, and provided that in the case of contacting with the deamidase, with or without the β-glucanase, the thermal stability of the provided particles having the PSD is enhanced.

31. The method of clause 29, wherein contacting is sufficient to provide particles having a particle size distribution (PSD) in the range of 0.1 μm to 5 μm, provided that in the case of contacting with the β-glucanase, with or without the deamidase, particles are neither ground to 10 μm or less nor filtered through a 10 μm or less filter in achieving the PSD, and provided that in the case of contacting with the deamidase, with or without the β-glucanase, the thermal stability of the provided particles having the PSD is enhanced.

32. The method of clause 29, wherein contacting is sufficient to provide particles having a particle size distribution (PSD) in the range of 0.1 μm to 5 μm, provided that in the case of contacting with the β-glucanase, with or without the deamidase, particles are neither ground to 5 μm or less nor filtered through a 5 μm or less filter in achieving the PSD, and provided that in the case of contacting with the deamidase, with or without the β-glucanase, the thermal stability of the provided particles having the PSD is enhanced

33. The method of any one of clauses 29-32, wherein the PSD of the provided particles is in the range of 0.1 to less than 5 μm, 0.1 μm to 4 μm, 0.1 μm to 3 μm, 1.0 μm to less than 5 μm, 1.0 μm to 4 μm, or 1.0 μm to 3 μm.

34. The method of clause 33, wherein the PSD of the provided particles is in the range of 1.0 μm to 3 μm.

35. The method of any one of clauses 29-34, wherein the provided particles having the PSD comprise β-glucanase cleavage products and/or deamidase cleavage products, and/or particles not having β-glucanase cleavage products and/or not having deamidase cleavage products, but which are released or otherwise rendered soluble by β-glucanase-mediated cleavage and/or deamidase-mediated cleavage of another component(s) of the base material.

36. The method of any one of clauses 29-35, wherein the provided particles having the PSD comprise protein, and/or carbohydrate, and/or lipid material.

37. The method of clause 36, wherein the lipid comprises one or more of fatty acids, glycerolipids, glycerophospholipids, sphingolipids, saccharolipids, and polyketides, sterol lipids, prenol lipids, waxes, oils, oil storage bodies, sterols, fats, fat-soluble vitamins (e.g., A, D, E, and K), monoglycerides, diglycerides, triglycerides, and/or phospholipids.

38. The method of any one of clauses 29-37, wherein treating comprises treating the base material with both the β-glucanase and the deamidase, either sequentially or at least in part contemporaneously.

39. The method of any one of clauses 29-37, wherein treating comprises contacting with the deamidase, but not the β-glucanase.

40. The method of any one of clauses 29-39, wherein treating with the β-glucanase, comprises treating with about 0.01 to about 1000 units/g base material, with about 0.025 to about 50 units/g base material, with about 0.05 to about 50 units/g base material, with about 0.05 to about 10 units/g base material, or with about 0.1 to about 10 units/g base material; and/or wherein treating with the deamidase(s) comprises treating in an amount and for a time-period sufficient to deamidate amino acid side chains of protein(s) of the base material, and/or of the β-glucanase-treated base material, and or of the provided particles, to modify (preferably enhance) thermal stability thereof, relative to non-deamidated forms of the plant proteins, and provide a thermally stabilized texture.

41. The method of clause 40, wherein enhancing the thermal stability comprises increasing one or more of the denaturation onset temperature, the coagulation peak temperature, and/or the denaturation midpoint temperature, in each case by a value in the range of 5 to 75° C., 10 to 70° C., 15 to 65° C., 20 to 60° C., 30 to 55° C., 35 to 50° C., or in any subrange within 5 to 75° C.

42. The method of any one of clauses 29-41, wherein, in the case of treating with the deamidase, the deamidase comprises glutamine deamidase and/or asparagine deamidase.

43. The method of clause 42, wherein contacting with the deamidase comprises: contacting with glutamine deamidase at about 0.01 to about 1000 units/g base material, at about 0.05 to about 75 units/g base material, or at: about 0.1 to about 15 units/g base material; and/or comprises contacting with asparagine deamidase at about 0.01 to about 1000 units/g base material, at about 0.05 to about 100 units/g base material, or at about 0.1 to about 30 units/g base material.

44. The method of any one of clauses 29-37, wherein contacting comprises contacting with the β-glucanase, but not the deamidase, preferably wherein contacting with the β-glucanase, comprises contacting with about 0.01 to about 1000 units/g base material, with about 0.025 to about 50 units/g base material, with about 0.05 to about 50 units/g base material, with about 0.05 to about 10 units/g base material, or with about 0.1 to about 10 units/g base material.

45. The method of any one of claims 29-44, comprising, prior to the grinding of the plant-based base material, wet or dry, to provide the PSD of less than 1 mm, heating the base material in an aqueous medium (e.g., alkaline aqueous medium), optionally followed by draining and/or rinsing.

46. The method of claim 45, wherein the base material is dried prior to the grinding.

47. The method of any one of claims 29-46, wherein coagulating the low heat stability proteins from the aqueous mixture of the ground base material, and the filtering thereof comprise bringing the ground base material in the aqueous mixture to at least 65° C. (e.g., preferably 75° C.) for 5 minutes before filtering using a 25 μm filter.

48. The method of any one of claims 29-47, further comprising, after the contacting with the β-glucanase and/or the deamidase, centrifuging the solution to provide an aqueous supernatant phase (whey) containing soluble and dispersed proteins, and optionally subjecting the supernatant phase to microparticulation to provide a plant-based non-dairy microparticulated whey.

49. The method of any one of claims 29-47, further comprising one or more of washing or otherwise cleaning, blanching, parboiling, boiling, drying, grinding, denaturing, coagulating, sedimenting, centrifuging, concentrating, filtering, and/or microparticulating the base material, either prior to, during, or after the contacting with the β-glucanase and/or with the deamidase

50. The method of clause 49, comprising centrifuging, or otherwise concentrating the provided particles having the PSD to provide an isolated particle concentrate suitable for use as a particle additive.

51. The method of clause 50, comprising use of the particle concentrate as, or as an additive for producing, a non-dairy plant-based milk, whey, half-and-half, cream, heavy cream, fermented product (e.g., yogurt, kefir, etc.), cheese, or powder; or use of the particle concentrate as an additive for producing a hybrid dairy, plant-based whey, milk, half-and-half, cream, heavy cream, fermented product (e.g., yogurt, kefir, etc.), cheese, or powder.

52. The method of clause 49, wherein drying the base material comprises adjusting the a_{w} to a value less than or equal to a value selected from the group consisting of 0.95, 0.90, 0.85. 0.80, 0.75, 0.70, 0.65, 0.6, 0.55, 0.5, 0.45, 0.4, 0.35, 0.3, 0.25, 0.2, 0.15 and 0.1, or less than or equal to a value in a range of 0.10 to 0.95, including adjusting to a value less than or equal to any value in any subranges therein (e.g., 0.20 to 0.85, 0.25 to 0.80, 0.25 to 0.75, 0.25 to 0.70, 0.25 to 0.65, 0.25 to 0.60, 0.25 to 0.55), preferably to a value in a range of 0.25 to 0.70.

53. The methods of any one of clause 29-52, wherein plant-based base material comprises or is a natural and/or a processed and/or restructured plant material.

54. The method of any one of clause 29-53, wherein the plant-based material comprises one or more of: oil seeds; nuts; legumes; and/or grains.

55. The method of clause 54, wherein; the oil seeds comprise one or more of pumpkin seeds, sunflower seeds, watermelon seeds, flax, and/or hemp; the nuts comprise one or more of almonds, walnuts, cashews, macadamia, and/or hazelnuts; the legumes comprise one or more of peanuts, and/or peas; and the grains comprise one or more of wheat, oat, corn, rye, sorghum, rice, barley, millet, fonio, amaranth, quinoa, and or buckwheat.

56. The method of clause 55, wherein the oil seeds comprise pumpkin seeds.

57. A food or beverage component, comprising a PSD component prepared by the method of any one of clauses 29-56.

58. The food or beverage component of clause 57, comprising or being a plant-based milk, plant-based half-and-half, plant-based cream, plant-based heavy cream, plant-based fermented product (e.g., yogurt, kefir, etc.), plant-based milk powder, plant-based whey or derivatives thereof, or plant-based cheese.

59. The food or beverage component of clause 58, comprising a combination of a dairy milk or a component or derivative thereof with the plant-based milk, plant-based half-and-half, plant-based cream, plant-based heavy cream, plant-based fermented product (e.g., yogurt, kefir, etc.), plant-based milk powder, plant-based whey or derivatives thereof, or plant-based cheese.

60. A non-dairy composition that replicates the texture of dairy milk or of a derivate thereof, comprising an enzymatically-treated plant-based material having deamidated plant protein(s) and/or β-glucanase-cleaved plant carbohydrate(s), the composition having a D90 particle size distribution (PSD) value in the range of 0.1 μm to 10 μm.

61. The composition of clause 60, wherein the D90 PSD of the plant-based particles is in the range of 0.1 μm to 5 μm.

62. The composition of clause 61, wherein the D90 PSD of the plant-based particles is in the range of 0.1 μm to less than 5 μm, 0.1 μm to 4 μm, 0.1 μm to 3 μm, 1.0 μm to less than 5 μm, 1.0 μm to 4 μm, or 1.0 μm to 3 μm.

63. The composition of clause 62, wherein the D90 PSD of the plant-based particles is in the range of 1.0 μm to 3 μm.

64. The composition of any one of clause 60-63, wherein the particles having the PSD comprise protein, and/or carbohydrate, and/or lipid material.

65. The composition of clause 64, wherein the lipid comprises one or more of fatty acids, glycerolipids, glycerophospholipids, sphingolipids, saccharolipids, polyketides, sterol lipids, prenol lipids, waxes, oils, oil storage bodies, sterols, fats, fat-soluble vitamins (e.g., A, D, E, and K), monoglycerides, diglycerides, triglycerides, and/or phospholipids.

66. The composition of any one of clauses 60-65, wherein the particles having the PSD comprise both deamidated plant protein(s) and β-glucanase-cleaved plant carbohydrate(s).

67. The composition of any one of clauses 60-66, wherein the particles having the PSD comprise deamidated plant protein(s), but not β-glucanase-cleaved plant carbohydrate(s).

68. The composition of any one of clauses 60-67, wherein, when deamidated plant protein(s) comprises glutamine-deamidated plant proteins and/or asparagine-deamidated plant proteins.

69. The composition of any one of clauses 58-66, wherein the amount of deamidated plant protein(s) in the particles having the PSD is sufficient to modify (preferably enhance) thermal stability thereof relative to non-deamidated forms of the plant proteins, and provide for a thermally stabilized texture.

70. The composition of clause 69, wherein relative to the non-deamidated plant protein, a coagulation peak, or denaturation midpoint of the deamidated plant protein in aqueous solution is increased by a value in the range of 5 to 75° C., 10 to 70° C., 15 to 65° C., 20 to 60° C., 30 to 55° C., 35 to 50° C., or in any subrange within 5 to 75° C.

71. The composition of any one of clauses 60-65, wherein the particles having the PSD comprise β-glucanase-cleaved plant carbohydrate(s), but not deamidated plant protein(s).

72. The composition of any one of clauses 60-71, wherein the composition is a constituent of a plant-based non-dairy whey.

73. The composition of any one of clauses 60-71, wherein the composition comprises or is an isolated particle concentrate suitable for use as a particle additive.

74. The composition of clause 73, wherein the composition is a constituent of: a non-dairy plant-based milk, whey, half-and-half, cream, heavy cream, fermented product (e.g., yogurt, kefir, etc.), cheese, or powder; or of a hybrid dairy, plant-based whey, milk, half-and-half, cream, heavy cream, fermented product, cheese, yogurt, or powder.

75. The composition of clause 74, wherein a_{w} of the powder is adjusted to a value less than or equal to a value selected from the group consisting of 0.95, 0.90, 0.85. 0.80, 0.75, 0.70, 0.65, 0.6, 0.55, 0.5, 0.45, 0.4, 0.35, 0.3, 0.25, 0.2, 0.15 and 0.1, or less than or equal to a value in a range of 0.10 to 0.95, including to a value less than or equal to any value in any subranges therein (e.g., 0.20 to 0.85, 0.25 to 0.80, 0.25 to 0.75, 0.25 to 0.70, 0.25 to 0.65, 0.25 to 0.60, 0.25 to 0.55), preferably to a value in a range of 0.25 to 0.70.

76. The composition of any one of clauses 60-75, wherein plant-based base material comprises or is a natural and/or a processed and/or restructured plant material.

77. The composition of any one of clauses 60-76, wherein the plant-based material comprises one or more of: oil seeds; nuts; legumes; and/or grains.

78. The composition of clause 77, wherein; the oil seeds comprise one or more of pumpkin seeds, sunflower seeds, watermelon seeds, flax, and/or hemp; the nuts comprise one or more of almonds, walnuts, cashews, macadamia, and/or hazelnuts; the legumes comprise one or more of peanuts, and/or peas; and the grains comprise one or more of wheat, oat, corn, rye, sorghum, rice, barley, millet, fonio, amaranth, quinoa, and or buckwheat.

79. The composition of clause 78, wherein the oil seeds comprise pumpkin seeds.

### BRIEF DESCRIPTION OF THE DRAWINGS

Those of skill in the art will understand that the drawings, described below, are for illustrative purposes only. The drawings are not intended to limit the scope of the present teachings in any way.

FIG. 1 shows, by way of non-limiting examples of the present invention, the relative particle size distribution PSD of pumpkin seed milk base that was β-glucanase treated (circles), and not β-glucanase treated (squares). The smaller PSD in the β-glucanase-treated milk base is due to the selective action of the exogenously added β-glucanase. The larger particle sizes of the β-glucanase-untreated milk base produced an inferior milk texture with noticeable granularity. The PSDs of these milks were determined using Dynamic Light Scattering (DLS) and Laser Diffraction (LD). The milk base treated with β-glucanase (e.g., Ultimase BWL-40™ from Novozymes, etc.) was analyzed using an Anton-Paar Litesizer 500. For comparison, the milk base not treated with β-glucanase was analyzed with an Anton-Paar PSA 1190LD.

FIG. 2 shows, by way of non-limiting examples of the present invention, a laser scanning optical micrograph of an exemplary pumpkin seed-based ‘milk’ base on glass. The diffuse gray areas are protein or other solute deposits. The laser enhances topographical contrast, such that the particles appear with black outlines. The sizes of these particles match those of pumpkin seed oil storage bodies (doi:10.1111/j.1744-7348.2008.00312.x; M. Kreft, et al., “Histolocalisation of the oil and pigment in the pumpkin seed,” Annals of Applied Biology, 154 (2009)). The pumpkin seed-based milk base was diluted 20× and deposited on glass, and the coated glass imaged using an Olympus OLS-41 laser scanning confocal microscope/profilometer.

FIGS. 3A and 3B show, by way of non-limiting examples of the present invention, a differential scanning calorimetry analysis comparing glutamine deamidase-treated (e.g., Amano PG500™) (FIG. 3B) and untreated (FIG. 3A) pumpkin seed-based whey. Treatment with the glutamine deamidase enzyme resulted in an increase in denaturation temperatures of nearly 50° C., showing a significant improvement in the thermal stability of the plant-based protein due to the action of this enzyme.

### DETAILED DESCRIPTION OF THE INVENTION

Unless otherwise noted (see “DEFINITIONS” below), terms are to be understood according to conventional usage by those of ordinary skill in the relevant art.

Aspects of the invention provide improved dairy and non-dairy compositions and methods for making same, including improved methods for making plant-based dairy analog compositions that replicate the texture and/or microstructural quality of dairy milk in various forms and/or show resilience against heat-induced structure change/loss. Preferably, the methods comprise enzymatic processing for making the dairy and non-dairy (e.g., plant-based) dairy analog compositions.

As stated above, to attain desired particle size distributions and/or desired texture, the industry has traditionally used relatively direct means, such as fine grinding, size filtration, and adding back or supplementing with new ingredients to replace what was removed/taken away. The presently disclosed methods provide a more elegant solution by working with nature rather than against it. Many seeds, for example, contain native structures that are <5 μm naturally, and according to particular aspects of the present invention, while such structures may be sequestered in larger assemblages in plant material, one need only liberate them to produce the desired dispersion for a dairy-replacing, plant-based milk. Pumpkin seed oil storage bodies, for example, are roughly spherical structures 1-5 μm in diameter (Kreft, M., et al., supra). Releasing and stabilizing these structures, rather than filtering them out as parts of larger aggregates resulting from mechanical grinding, would have the dual benefit of enhanced product quality, and wasting less and delivering more of the native structures in the desired size range.

Likewise, according to additional aspects, deamidation of particular amidated native amino acid side chains in plant-based proteins (e.g., in a plant-based milk, etc.) provides for one or more of modulated (e.g., enhanced) solubility, functionality (e.g., emulsification, foaming, etc.), and/or thermal stability (preferably providing for enhanced thermal stability), with attendant reduced denaturation and/or coagulation at conventional thermal processing temperatures-allowing for retention of the stabilized components, and/or retention of other structures, including non-protein structures that may otherwise be affected (e.g., entrapped or co-coagulated with) by otherwise denaturing and/or coagulating protein structures. Glutamine and/or asparagine, for example, may simultaneously appear in proteins in their respective side-chain deamidated forms (glutamic and aspartic acids, respectively), depending on the metabolic processes of the species in question. Significantly, the acid and amide forms of such amino acids have very different solution properties; the acid forms being relatively more soluble and retaining that enhanced solubility at higher temperatures relative to the amidated forms. According to further aspects, however, because the acid forms of such amino acids are less soluble upon protonation at lower pH values, the disclosed methods may comprise shifting/adjusting the equilibrium between deamidated and amidated amino acid side chains in the protein to achieve the desired balance between thermal stability and solubility at lower pH values.

Aspects of the invention provide inexpensive, enzyme-based methods for the production of plant-based milks with optimal particle size distributions (e.g., 0.1 to 10 μm; 0.1 to 5 μm; preferably in the 0.1-3 μm range). The methods preferably require no fine filtering (as defined herein) or fine grinding (as defined herein) to exclude all particles having PSD values greater than 10 μm or greater than 5 μm, nor the addition of exogenous dispersed ingredients (e.g., oils, fats, butters, microcrystalline cellulose or other insoluble powders, etc.) to provide particles having PSD values in the range of 0.1 to 5 μm or 0.1 to 10 μm. Rather, the native components of the base ingredient (e.g., almonds in the case of almond milk) are broken down to the appropriate desired size using one or more enzymes (e.g., polysaccharide cleaving enzymes, proteases, lignin-lyases, deamidases, etc.), preferably comprising a β-glucanase and/or a deamidase. While not being bound by any particular mechanism, enzymes such as β-glucanase and/or deamidases are used, preferably when appropriately selected for a given plant material, to selectively cleave/lyse matrix materials (e.g., polysaccharides, protein, lignin, cellulose, etc.) that otherwise surround and sequester core oil storage bodies or other native plant core structures or particles, while leaving the liberated core structure(s) (having the desired particle size) largely unchanged. According to preferred aspects, therefore, by appropriate enzyme process design, the optimal PSD of homogenized dairy milk may be sufficiently mimicked starting from a plant-based material, with no requirement for fine grinding (as defined herein) or fine filtering (as defined herein), nor to add or supplement with exogenous ingredients to provide particles having PSD values in the range of 0.1 to 5 μm. Moreover, since such native core structures are preferably not cleaved/lysed by these enzymes (or at least differentially resilient to these enzymes), when appropriately chosen, it is not possible, or at least less likely, to over-process them by reducing particle sizes below the optimal range.

According to additional aspects of the methods, in the case of plant-based milks with low thermal stability, the use of deamidating enzyme(s) (e.g., glutamine and/or asparagine deamidases) allows ideal or preferred protein-comprising structures, and/or other structures including non-protein structures that otherwise might be affected by them, to be maintained through high temperature heat processing (ex: retort, UHT). These high temperatures used for sterilizing food and beverage products, in many cases, would otherwise cause denaturation and/or coagulation of the plant-based protein, which in turn might entrap other desired structures (protein and/or non-protein). Such denaturation and/or coagulation harms two important properties of, e.g., an ideal plant-based milk: (i) texture (curds are not preferred in fluid milk); and (ii) functionality (e.g., the ability to foam and/or emulsify, where coagulated protein generally has reduced capacity for foaming and/or emulsification, etc.). By converting these naturally occurring residues to their alternative, more heat-stable yet still naturally occurring form, the ability of these deamidated proteins, and other structures that otherwise may be lost, to survive modern, high temperature processing methods is enhanced. As in the case with the disclosed enzymatic size reduction methods, this is preferably and readily accomplished enzymatically (e.g., by deamidating enzymes), however a chemical approach (e.g., acids/bases, etc.) might be employed for this action. Additionally, like the enzymatic size reduction methods, thermal stabilization processes involving deamidation (e.g., enzyme-mediated) are also self-limiting; that is, when no pendant side-chain amides remain, the process stops. There is essentially no danger of over-processing, and if needed, the reaction conditions (e.g., time, enzyme concentration, etc.) may be varied to shift/adjust the equilibrium between deamidated and amidated amino acid side chains in the protein to achieve a desired balance between thermal stability and solubility at lower pH values.

Provided, therefore, are compositions and methods for the production of heat stable plant-based dairy analogs that more accurately replicate the organoleptic qualities (e.g., texture, etc.) of dairy milk in various forms, and that show resilience against heat-induced structure change/loss (e.g., denaturation and/or coagulation). These compositions are achieved by replicating a key microstructural quality of dairy milk (e.g., fresh dairy milk, homogenized dairy milk, etc.); that is, a dispersion with particle or droplets sizes less than or equal to 10 μm or less than or equal to 5 μm, preferably having PSD in the range of 0.1-5 μm, most preferably having PSD in the range of 1-3 μm. Preferably, this is achieved through the use of suitable enzyme treatments. As disclosed herein, for example, β-glucanase enzyme(s), are used to selectively, or at least differentially, disassemble plant polysaccharide matrix structure(s), while leaving intact desired core components (e.g., oil storage bodies, etc.) having the ideal or preferred size range. Furthermore, also as disclosed herein, such dispersions (e.g., milks) may be given, or may additionally be given, substantial resistance to thermal denaturation and/or coagulation through the use of glutamine and/or asparagine deamidase enzymes.

### Production Methods

Cleaning and/or separation. Base material (e.g., raw plant-based ingredients) may be cleaned and prepared for use in the methods by one or more various methods including, but not limited to mechanical (e.g., hulling, peeling, etc.), chemical (e.g., alkaline, or acidic pH, salt(s), etc.), and/or enzymatic (e.g., pectinase, ligninase, etc.).

Additionally, foreign matter or plant base material that fails to meet quality standards (e.g., broken, inappropriate sizes, discolored, etc.) may be separated/removed based on any suitable differential material property (density, and/or optical, and/or size, etc.).

Initial Heat Treatment. Base material ingredients may be treated, either in a separate step or in combination with one or more other steps (e.g., with a cleaning and/or separation step), with any suitable form of wet (e.g., steaming, blanching, etc.) or dry (roasting, microwaving, etc.) heat, or with heat removal (e.g., chilling, freezing, etc.) prior to further processing. Such heat treatment(s), at suitable temperatures (e.g., 60-150° C., 70-130° C., 80-120° C., 150-250° C., 175-225° C., 180-220° C., etc.), may be used, for example, to provide for microbial or enzymatic deactivation, peeling (e.g., in combination with alkaline conditions), extraction of undesirable constituents, and/or or to modify the structure or a property of the base material (e.g., to make it more amenable to further processing steps, etc.).

Fragmentation/grinding. The base material, or a cleaned, and/or separated, and/or heat-treated derivative thereof, may be subjected to fragmentation (e.g., grinding). Any suitable fragmentation/grinding method could be used, including but not limited to dry methods (e.g., knife mill, attrition mill, etc.), and/or wet methods (e.g., blending, stone milling, etc.), and/or any other suitable conventional mechanical method, sonic (e.g., ultra-sonic) method, and/or other suitable fragmentation/grinding methods. Such fragmentation/grinding methods may be further modified and/or enhanced by adjustment of parameters such as temperature and/or chemistry (ex: pH), and/or by augmentation with enzymes that assist in size modulation (preferably size reduction). The resulting product may or may not be sieved, classified, etc. depending on the circumstances.

Extraction. Extraction of valuable and/or desired constituents in the base material, or in a cleaned, and/or separated, and/or heat-treated, and/or fragmented/ground derivative thereof, may be performed. Such extraction(s) is preferably conducted primarily in water, however other appropriate solvents such as ethanol, vegetable oil, or any other suitable solvent or mixtures thereof may be used for extraction/partitioning purposes. Optionally, the extraction mixture(s) may be brought to higher or lower temperatures, depending on the solvent(s) and the solubility and/or other thermal behavior/property of the solvent and/or of the extraction media. Extraction(s) may be further controlled by the use of one or more additives, including but not limited to salts (e.g., sodium and/or potassium salts (e.g., chlorides, phosphates, sulfates, etc.), magnesium salts, calcium salts, etc.) that may serve to modulate (enhance or reduce) the solubility of particular components (e.g., proteins, lipids, carbohydrates, polysaccharides, etc.) in water. Likewise, pH of the extraction component(s) may be adjusted (e.g., by addition of acids and bases, suitable buffer salts, etc.) may be added to modify the solubility of proteins and/or other constituents. Additionally, enzymes may be added to modulate extraction(s). These could take many forms, such as hydrolytic enzymes that break down larger constituents into smaller, more soluble components, and/or enzymes that modify proteins or other components of the base material to render them more soluble (e.g., deamidation enzymes, lyases and hydrolyases, transferases (e.g., glycosylation, phosphorylation, acetylation, etc.), oxioreductases (e.g., thioredoxin, methane monooxygenase, etc.), etc.). Undesirable components/fractions could also be made less soluble by, for example, cross linking, amidation or other suitable mechanisms (e.g., salting out, solvent exchange, etc.). Extraction(s) may comprise one, or may comprise serial extractions (e.g., extracting desired or undesired components, in either order).

Post-extraction separation. After extraction, base material components/fractions may be separated into desirable and undesirable streams using a variety of suitable methods, including but not limited to use of salt(s), solvent changes/exchanges, gravity/decanting separation, normal and transverse flow filtration, centrifugation, etc., and may optionally include the use of filter aids or other modifications (e.g., pH or temperature changes, etc.) that modify the performance of a chosen filtration method. Additional post-extraction separation may involve the removal of solvents or undesirable components (e.g., by vacuum and/or or thermal evaporation, diffusive concentration (e.g., forward or reverse osmosis), liquid-liquid extractions, and/or other methods known in the art).

Finishing treatment. The resulting cleaned, and/or separated, and/or heat-treated, and/or fragmented/ground, and/or extracted base material may be further processed to enhance its properties. Such further processing may comprise use of one or more suitable enzymes, including but not limited to lyases (e.g., β-glucanase, mannanase, galactomannanase, xylanases, etc.), and/or proteases, and/or lipases, etc., to improve particular properties such as the PSD of dispersed material, and/or modify (e.g., add/impart, or reduce) sweetness, and/or other desired flavor and/or desired texture component.

Additional further processing enzymes may include deamidases (e.g., for deamidation of glutamine and asparagine side-chains of base material proteins and polypeptides (e.g., to provide for enhanced thermal stability as discussed above). Preferred deamidases are those that can act on proteins and polypeptides, and that are not specific to isolated amino acids. Chemical deamidation (e.g., acid or base catalyzed) may additionally or alternatively be used.

Additionally, enzymes that act across protein chains, such as transglutaminase (e.g. that catalyze the formation of an isopeptide bond between γ-carboxamide groups of glutamine residue side chains and the ε-amino groups of lysine residue side chains), may be used to impart desired interactions between separate protein molecules (e.g., such as binding proteins together). Alternatively, or in addition, thioredoxin, sodium bisulfite, or another suitable food grade reducing agent can be used to reduce disulfide bridges within and/or between base material proteins to modify PSD.

Finishing treatments may additionally include inoculation with microorganisms (e.g., bacteria, yeast, mold), with or without a pasteurization/sterilization step preceding such inoculation. Parameters such as mixing and/or temperature, and/or pH and/or redox potential and/or atmosphere (e.g., air, CO₂, etc.) may be controlled to support the growth of desired microorganisms. Likewise, further substrates and/or nutrients, etc. for microbial metabolism may be added to direct the product, in a batch or continuous mode, to a desired end state. These microbial processes (e.g., fermentation(s)) may proceed for anywhere from hours to weeks or months, depending on the desired output (ex: yogurt vs. cheese, etc.). Post-fermentation processing (e.g., pasteurization, sterilization, cutting, forming, packaging, infusion, formulating, blending with liquids or solids (e.g., fruit/vegetable purees or flavors, etc.) centrifugation, concentration, cheddaring, pressing, etc.) may be employed.

Formulating. The milk base resulting from the above steps may additionally be formulated with ingredients that modify various properties. These include texture modifiers (such as gums), emulsifiers (e.g., lecithin, etc.), soluble or insoluble solvents (e.g., ethanol, propylene glycol, vegetable oil, etc.), salts (e.g., sodium and/or potassium and/or magnesium and/or calcium salts (e.g., chlorides, phosphates, sulfates, etc.), magnesium salts, calcium salts, etc.), coagulants (e.g., acids, etc.), sweeteners, colors or opacifiers, flavors, nutritional fortification ingredients (e.g., vitamins, minerals, etc.), bioactive compounds e.g., caffeine, antioxidants, etc.) or other milks (plant-based or otherwise) to achieve the desired final dairy milk analog, or derivative(s) thereof, including hybrid dairy/non-dairy compositions and derivatives. Filtering and/or pressing may also be employed during or as a part of formulation (e.g., for formulation of curds, etc.).

The non-dairy products (e.g., plant-based milk, or the provided particles thereof having the PSD) produced by the methods may additionally be concentrated (e.g., centrifugation, tangential flow concentration, etc.) and/or blended with other ingredients (e.g., such as those described above) to produce products other than fluid milk (e.g., to provide creamers, evaporated/condensed non-dairy milk, bakery, confections, desserts, ice cream bases, and/or cultured products such as yogurt or cheeses, etc.).

Optional formulations are provided by blending the plant-based material (e.g., milk or base material) with components such as coffee, tea, fruit or fruit purees. chocolate, soups, sauces, and/or other non-milk bases to make a non-dairy milk food or beverage.

Thermal/mechanical processing. As in the case of dairy milk, plant-based fluid milk or milk concentrates can be rendered shelf stable by art recognized methods such as retort, ultra high temperature (UHT) sterilization, microwave-assisted processes, high pressure processing (HPP), and the like. Related processes (e.g., heating by heat exchangers, microwaves, direct steam injection, etc. with different time, temperature and/or filling protocols that, in isolation, do not result in shelf stable products, etc.) may also be used in or for the production of pasteurized or extended shelf-life refrigerated products. Drying techniques such as refractance window, spray drying and other art recognized techniques may be used to create dry powders (e.g., dry plant-based milk powder, etc.).

Thermal/mechanical processing methods may additionally include low temperature processes. For example, these products may be chilled and churned to produce a non-dairy ice cream, or frozen for long-term storage.

In further aspects, thermal/mechanical processing of plant-based compositions (e.g., the soluble protein fraction) may be subjected to a microparticulation process. Microparticulation may comprise, for example, a high temperature and high shear process that causes the proteins to coagulate while being subjected to shear fields that result in protein particles in the desired or ideal range for creating a rich texture (e.g., organoleptic creaminess provided by the disclosed preferred PSD ranges). Conditions in the composition being subjected to microparticulation may be adjusted (e.g., by modifying the pH or ionic strength) to modify (e.g., promote, retard) the coagulation of protein during the microparticulation processing. The resulting microparticulated plant-based composition mixture may then be utilized in any number of formats or applications, including but not limited to concentrates, dried formats, use as a protein supplementation, texture modification, etc., in formulations with other/additional components, etc.

### Exemplary Base Materials/Ingredients

### Oil Seeds (Exemplary):

Pumpkin seeds (e.g., Curcubita pepo);
Sunflower seeds (e.g., Helianthus annuus);
Watermelon seeds (e.g., Citrullus lanatus);
Flax (e.g., Linum usitatissimum); and
Hemp (e.g., Cannabis sativa).

### Nuts (Exemplary):

Almonds (e.g., Prunus dulcis);
Walnuts (e.g., Juglans regia);
Cashews (e.g., Anacardium occidentale);
Macadamia (e.g., Macadamia intergrifolia); and
Hazelnut (e.g., Corylus sp.).

### Legumes (Exemplary):

Peanuts (e.g., Arachis hypogea); and
Peas (e.g., Pisum sativum).

### Grains (Exemplary; Cereal/Non-Cereal):

Wheat (e.g., Triticum aestivum);
Oat (e.g., Avena sativa);
Corn (Maize);
Rye (e.g., Secale cereale);
Sorghum (genus Sorghum, e.g., Sorghum bicolor);
Rice (e.g., Oryza sativa and glaberrima);
Barley (e.g., Hordeum vulgare)
Millet (e.g., Penniesetum glaucum);
Fonio (e.g., Digitaria exilis)
Amaranth e.g., (Amaranthus caudatus, cruentus and hypochrondriacus)
Quinoa (e.g., Chenopodium quinoa); and
Buckwheat (e.g., Fagopyrum esculentum).

### Definitions

Unless otherwise indicated:

“Water activity (a_{w}),” as used herein, refers to the art-recognized meaning, e.g., the partial vapor pressure of water in a substance divided by the standard state partial vapor pressure of water. In the field of food science, the standard state is most often defined as the partial vapor pressure of pure water at the same temperature. Using this particular definition, pure distilled water has a water activity of exactly one.

“Natural plant material,” as used herein, includes but is not limited to those exemplary plant materials listed herein that come from plants, and may include restructured (e.g., fragmenting, grinding, milling, micronizing, depolymerizing (e.g., chemically, enzymatically, etc.), solubilizing, permeabilizing, compacting and/or compressing) plant material.

“D90 value” as used herein and generally recognized in the art, refers to the diameter at the 90th percentile (90%) of the cumulative distribution of particle sizes, where that cumulative distribution may be on the basis of particle number, volume, or weight. Unless stated otherwise, the cumulative distribution is on the basis of particle volume.

“Coarse grinding” or “coarse grind”, as used herein, generally refers to grinding to a D90 value greater than or equal to 500 μm.

“Fine grinding” or “fine grind” or “finely ground”, as used herein, generally refers to refers to grinding to a D90 value less than 500 μm (e.g., preferably, less than 100 μm), but greater than 5 μm (or, if indicated, greater than 10 μm).

“Fine filtering”, as used herein, generally refers to filtering particles to exclude particle sizes above 5 μm (or, if indicated, above 10 μm), to achieve a filtrate PSD value in the range of 0.1 to 5 μm (or, if indicated, of 0.1 to 10 μm).

“Particle size distribution” or “PSD”, as used herein, generally refers to a particle size distribution (PSD) having a particular D90 value. For example, a PSD in the range of 1.0 μm to 3 μm, refers to a particle distribution having a D90 value in the range of 1.0 μm to 3 μm.

“Microparticulation” as used herein, refers to an art recognized (e.g., high temperature and high shear) process that causes the proteins to coagulate while being subjected to shear fields that result in protein particles in the desired or ideal range for creating a rich texture (e.g., organoleptic creaminess provided by the disclosed preferred PSD ranges). Conditions in the composition being subjected to microparticulation may be adjusted (e.g., by modifying the pH or ionic strength, etc.) to modify (e.g., promote, retard) the coagulation of protein during the microparticulation processing (See, e.g., Singer, N. S. & J. M. Dunn, J. M., “Protein Microparticulation: The Principle and the Process,” Journal of the American College of Nutrition, Vol. 9 No. 4, 388-397 (1990); DOI: 10.1080/07315724.1990.10720397).

“β-Glucanase”, as used herein, refers to an enzyme that breaks down (1,4)-β-glucosidic linkages (e.g., in cellulose and other β-D-glucans). Preferred β-Glucanases are also xylanses (β-glucanase/xylanase; e.g., Ultimase BWL-40™ from Novozymes, etc.).

“Deamidase”, as used herein, refers to an enzyme that converts amidated amino acids (e.g., present in proteins) into the corresponding acid form. For example, glutamine deamidase (e.g., Amano PG500™, etc.) converts glutamine residues, including in proteins, to glutamic acid residues; and asparagine deamidase (e.g., Acrylaway® or Acrylaway® HighT from Novozymes, etc.) converts asparagine residues, including in proteins, to aspartic acid residues, etc.).

### Exemplary Preferred Ranges:

PSD particle sizes: 0.1-5 μm (preferred); 0.1-3 μm (more preferred); and 1-3 μm (most preferred).
Enzyme concentrations (*U/g is units per gram of substrate material (e.g., pumpkin seeds)):
   β-glucanase (e.g., Ultimase BWL-40™ from Novozymes, etc.): 0.01-1000 units, 0.025-50 units (preferred), 0.05-50 units (more preferred), 0.05-10 units/g (most preferred), or 0.1-10 units/g;
   Glutamine deamidase (e.g., Amano PG500™, etc.): 0.1-15 units/g (most), 0.05-75 units/g (more), 0.01-1000 units/g (preferred); and
   Asparagine deamidase (e.g., Acrylaway® or Acrylaway® HighT from Novozymes, etc.): 0.1-30 units/g (most), 0.05-100 units/g (more), 0.01-1000 units/g.

### Temperatures (Thermal Steps):

β-glucanase: 0-85° C. (preferred); 0-75° C. (e.g., 10-75° C.) (more preferred); and 0-60° C. (e.g., 30-60° C.) (most preferred); and
Deamidases: 0-75° C. (preferred); 0-65° C. (e.g., 35-65° C.) (more preferred); 0-60° C. (e.g., 45-60° C.) (most preferred) and preferably not greater than 65° C.
   pH:
β-glucanase: 2.0-9.0 (preferred); 3.0-7.0 (more preferred); and 4.6-6.0 (most preferred); and
Deamidases: 2-11 (preferred); 4.5-9.0 (more preferred); and 5.0-8.0 (most preferred).

### Timing for Steps:

β-glucanase: 1-240 minutes (preferred); 15-120 minutes (more preferred); and 30-90 minutes (most preferred); and
Deamidases: 1-240 minutes (preferred); 15-120 minutes (more preferred); and 30-90 minutes (most preferred).

### EXAMPLES

The following non-limiting examples are provided to further illustrate embodiments of the invention disclosed herein. It should be appreciated by those of skill in the art that the techniques disclosed in the examples that follow represent approaches that have been found to function well in the practice of the invention, and thus can be considered to constitute examples of modes for its practice. However, those of skill in the art should, in light of the present disclosure, appreciate that many changes can be made in the specific embodiments that are disclosed and still obtain a like or similar result without departing from the spirit and scope of the invention.

Exemplary preferred ranges for particle size distribution (PSD), enzyme concentrations, temperatures, pHs, and timing of steps are summarized under “Definitions”

TABLE 1
Summary of Examples

| Example | Subject matter |
|---|---|
| 1 | A non-dairy, pumpkin seed milk having a particle size |
| | distribution (PSD) of 1-3 μm was produced using β-glucanase |
| 2 | A non-dairy, pumpkin seed milk having enhanced thermal |
| | stability and a particle size distribution (PSD) of 1-3 μm was |
| | produced using β-glucanase and glutamine deamidase |
| 3 | A non-dairy, pumpkin seed milk having enhanced thermal |
| | stability and a particle size distribution (PSD) of less than |
| | 5 μm was produced using fine filtration and glutamine |
| | deamidase |
| 4 | A non-dairy, sunflower seed milk having a particle size |
| | distribution (PSD) of 1-3 μm is produced using β-glucanase |
| 5 | A non-dairy, almond seed milk having a particle size |
| | distribution (PSD) of 1-3 μm is produced using β-glucanase |
| 6 | A non-dairy, oat milk having a particle size distribution |
| | (PSD) of 1-3 μm is produced using β-glucanase |
| 7 | A non-dairy, almond and pumpkin seed milk having a |
| | particle size distribution (PSD) of 1-3 μm is produced using |
| | β-glucanase |
| 8 | A canned latte comprising traditional coffee in combination |
| | with pumpkin seed milk is produced |
| 9 | A canned latte comprising a coffee substitute in |
| | combination with pumpkin seed milk was produced |
| 10 | A non-dairy ice cream base was prepared from a pumpkin |
| | seed base material |
| 11 | A non-dairy, microparticulated pumpkin seed whey is |
| | prepared |
| 12 | A non-dairy, microparticulated pumpkin seed whey milk, |
| | and thermally stable whey milk latte is prepared |
| 13 | A non-dairy, microparticulated pumpkin seed whey protein |
| | additive is prepared |
| 14 | A non-dairy, particle dispersion prepared from pumpkin |
| | seeds is used to prepare a non-dairy cheese sauce |
| 15 | A non-dairy pumpkin seed cheese, or a hybrid cheese |
| | including dairy, is prepared |
| 16 | Enhanced thermal stability was demonstrated by |
| | comparing denaturation temperature ranges of deamidase- |
| | treated vs untreated pumpkin seed material |

### Example 1

### (A Non-Dairy, Pumpkin Seed Milk Having a Particle Size Distribution (PSD) of 1-3 μm was Produced Using β-Glucanase)

Cleaned pumpkin seeds (100 g) were blanched at 85° C. for 20 minutes in 400 g water (optionally with an alkalizing agent) at a pH of 6-12 (preferably 7-10.5, more preferably 8-10), then drained and rinsed. The blanched seeds were then dried for about 6 hours at 55° C. to achieve a safe water activity (a_{w}; e.g., less than or equal to 0.85). The dried seeds were coarse ground (D90 value greater than 500 μm; e.g., greater than 500 μm up to an including to 1 mm, or to 2 mm) using a knife mill. This coarsely ground seed meal was added to 600 g of water and ground fine (D90 value greater than 5 μm; e.g., greater than 5 μm up to and including 500 μm) (e.g., in a Silverson L5M-A rotor stator with a fine screen for 15 minutes at 8000 RPM). Antioxidants (e.g., vitamin E, mixed tocopherol, etc.) may optionally be added to preclude or retard oxidation during and/or after the grinding. Coarse and fine grinding may optionally be performed as a continuous or discontinuous process, wet or dry, in the context of a single, or multiple grinding stage-based process. Low heat stability protein was then thermally coagulated by bringing the finely ground mixture to 65° C. for 5 minutes before filtering using a 25 μm filter. The filtered pumpkin seed milk base was treated with 40 units (0.4 units/g pumpkin seeds) of β-glucanase (e.g., Ultimase™ from Novozymes, etc.), adjusted to pH 5 (e.g., with phosphoric acid), and the temperature brought to 55° C. and maintained for 1 hour with stirring. After the 1 hour, the β-glucanase-treated pumpkin seed milk base was chilled to 4° C. The particle size distribution (PSD) was determined (after isolating the particles by decanting and centrifuging) using Dynamic Light Scattering (DLS) and Laser Diffraction (LD). The PSD of the milk base treated with β-glucanase was analyzed using an Anton-Paar Litesizer 500. For comparison, a control milk base, identically processed but not treated with β-glucanase, was analyzed with an Anton-Paar PSA 1190LD.

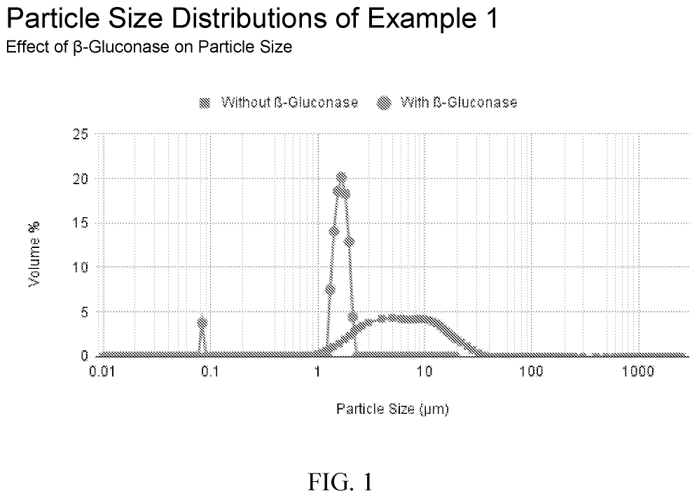

The resulting PSDs are depicted in FIG. 1, which shows the relative PSD of pumpkin seed milk base (after the filtering and β-glucanase treatment, and before any finishing or formulating) that was β-glucanase-treated (circles), and not treated (squares), with β-glucanase. The smaller particle sizes in the β-glucanase-treated milk base are due to the selective action of the exogenously added β-glucanase. The larger particle sizes of the untreated milk base produced an inferior milk texture with noticeable granularity.

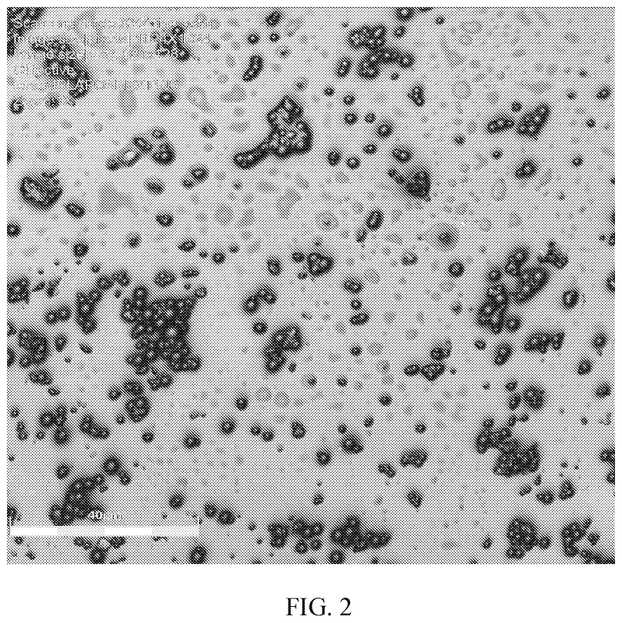

The β-glucanase-treated pumpkin seed-based milk base was diluted 20× and deposited on glass, and the coated glass imaged using an Olympus OLS-41 laser scanning confocal microscope/profilometer. FIG. 2 shows a laser scanning optical micrograph of the pumpkin seed-based milk base on glass. The diffuse gray areas are protein or other solute deposits. The laser enhances topographical contrast, such that the particles appear with black outlines. The sizes of these particles generally match those of pumpkin seed oil storage bodies (Kreft, M., et al., supra).

Formulation. For this exemplary embodiment, the pumpkin seed-based milk base was formulated by blending with sugar, salt (neutralized with KOH), water, gellan gum (0.03%) and guar gum (0.05%) to create a complete non-dairy milk having a milk-like texture.

According to aspects of the present invention, treating the coarse filtered pumpkin seed milk base with β-glucanase eliminated the need for grinding or fine filtering (as defined herein) the particles to exclude sizes above 5 μm to achieve the PSD.

### Example 2

### (A Non-Dairy, Pumpkin Seed Milk Having Enhanced Thermal Stability and a Particle Size Distribution (PSD) of 1-3 μm was Produced Using β-Glucanase and Glutamine Deamidase)

Pumpkin seed milk base was prepared as in Example 1, but the filtered milk base was additionally treated with 300 units (3.0 units/g pumpkin seeds) of glutamine deamidase (e.g., Amano PG500) during the β-glucanase treatment. In alternative embodiments, asparagine deamidase may be used, including in combination with glutamine deamidase. The resulting milk, formulated as in Example 1, was treated under UHT conditions (140° C./6 seconds) in parallel with a like portion of the formulated milk of Example 1. Relative to the milk produced in this Example 2, the Example 1 milk (no deamidase treatment) yielded a coarser texture and exhibited some coagulation and/or sedimentation and the stable (non-coagulated/non-sedimented) protein fraction was only 1% of the total mass of the finished milk. By contrast, the post-UHT milk of this Example 2 showed no sedimentation and retained a relatively rich texture through UHT processing. Moreover, the post-UHT stable (e.g., no coagulation and/or non-sedimented) protein in this Example 2 milk was 3% of the total mass/finished milk.

According to aspects of the present invention, treating the coarse filtered pumpkin seed milk base with β-glucanase and deamidase eliminated the need for grinding or fine filtering the particles to exclude sizes above 5 μm to achieve the PSD.

According to additional aspects of the present invention, treating the coarse filtered pumpkin seed milk base with β-glucanase and deamidase enhanced the thermal stability of the produced particles having the PSD in the milk.

### Example 3

(A Non-Dairy, Pumpkin Seed Milk Having Enhanced Thermal Stability and a Particle Size Distribution (PSD) of Less than 5 μm was Produced Using Fine Filtration and Glutamine Deamidase)

Cleaned pumpkin seeds (100 g) were blanched at 85° C. for 20 minutes in 400 g water (optionally with an alkalizing agent, e.g., 2.5 g sodium bicarbonate), then drained and rinsed. The rinsed seeds were optionally dried for 6+ hours at 55° C. to provide for a safe water activity (a_{w}; e.g., less than or equal to 0.85). The dried seeds were coarse ground using a knife mill. This coarse seed meal was added to 600 g of water and ground fine (D90 value greater than 5 μm; e.g., greater than 5 μm up to an including 500 μm) (e.g., in a Silverson L5M-A rotor stator with a fine screen for 15 minutes at 8000 RPM). Antioxidants (e.g., vitamin E, mixed tocopherol, etc.) may optionally be added to preclude or retard oxidation during and/or after the grinding. Coarse and fine grinding may optionally be performed as a continuous or discontinuous process, wet or dry, in the context of a single, or multiple grinding stage process. Low stability protein was then thermally coagulated by bringing this mixture to 65° C. for 5 minutes before filtering using a 5 μm filter to exclude PSD values above 5 μm. The filtered milk base was treated with 300 units (3 units/g pumpkin seeds) of glutamine deamidase, adjusted to pH 6 (e.g., with phosphoric acid) and the temperature brought to 55° C. This temperature was maintained for 1 hour with stirring. After 1 hour, the milk was chilled to 4° C. Like the milk of Example 2 above, the resulting milk survived UHT processing without coarsening texture nor sedimenting protein (e.g., no coagulation and/or sedimentation).

Alternatively, prior to thermally coagulating, the finely ground material was treated with 300 units (3 units/g pumpkin seeds) of glutamine deamidase, adjusted to pH 6 and the temperature brought to 55° C. for 1 hour. The mixture was then thermally coagulated and filtered as described above. The 5 μm filtration process when the amidase enzyme was used prior to the thermal coagulation was noticeably easier (relative to 5 μm filtering the non-amidase-treated coagulated mixture), with substantially increased filtrate flow rate, and with lower pressures necessary to complete the filtration.

According to aspects of the present invention, treating the coarse filtered pumpkin seed milk base with deamidase substantially enhanced the filterability of particles to exclude sizes above 5 μm to achieve the PSD.

According to further aspects of the present invention, contacting with the deamidase, with or without the β-glucanase, substantially enhanced the thermal stability of the provided particles having the PSD in the milk.

### Example 4

### (A Non-Dairy, Sunflower Seed Milk Having a Particle Size Distribution (PSD) of 1-3 μm is Produced Using β-Glucanase)

Whole sunflower seeds (100 g) are toasted at 85° C. and then fine ground to a butter using a stone mill. The paste is dispersed in water and blended with high shear to produce a homogeneous mixture. The pH of the mixture is raised to 10 with KOH and stirred for 20 minutes (45° C.) for extraction. Coarse material is filtered out with a 50 μm filter mesh and the pH of the filtrate adjusted to 6 with lactic acid. Forty (40) units of β-glucanase (0.4 units/g sunflower seeds) are added and the temperature raised to 55° C. for 60 minutes of processing with stirring. The resulting material is chilled to 4° C. The resulting milk has a rich and smooth texture, as determined by sensory analysis.

According to aspects of the present invention, treating the coarse filtered sunflower seed milk base with β-glucanase eliminated the need for grinding or fine filtering the particles to exclude sizes above 5 μm to achieve the PSD.

### Example 5

### (A Non-Dairy, Almond Seed Milk Having a Particle Size Distribution (PSD) of 1-3 μm is Produced Using β-Glucanase)

Blanched, skinned almonds (100 g) are coarse ground using a knife mill to a particle size <1 mm. The resulting meal is then ground fine using a Silverson L5M-A rotor stator in 500 g water. The resulting mixture is filtered using a 25 μm filter membrane, then brought to pH 6 and 55° C. Forty (40) units of β-glucanase (0.4 units g almonds) is added and allowed to process for 60 minutes with stirring before cooling the milk to 4° C. The milk has a smooth texture and rich mouthfeel.

According to aspects of the present invention, treating the coarse filtered almond seed milk base with β-glucanase eliminated the need for grinding or fine filtering the particles to exclude sizes above 5 μm to achieve the PSD.

### Example 6

### (A Non-Dairy, Oat Milk Having a Particle Size Distribution (PSD) of 1-3 μm is Produced Using β-Glucanase)

Whole oat groats (100 g) are ground using a stone mill to a particle size of 200-500 μm. This flour is then fine grinded using a Silverson L5M-A rotor stator in 500 g water. The resulting mixture is filtered using a 25 μm filter membrane, then brought to pH 5 and 55° C. Forty (40) units of β-glucanase (0.4 units g oat groats) is added and allowed to process for 60 minutes with stirring before cooling the milk to 4° C. The milk has a smooth texture and rich mouthfeel.

According to aspects of the present invention, treating the coarse filtered oat seed milk base with β-glucanase eliminated the need for grinding or fine filtering the particles to exclude sizes above 5 μm to achieve the PSD.

### Example 7

### (A Non-Dairy, Almond and Pumpkin Seed Milk Having a Particle Size Distribution (PSD) of 1-3 μm is Produced Using β-Glucanase)

The milks of Examples 1 and 4 are combined to create a mixed almond-pumpkin seed milk with flavor notes of both almond and pumpkin seed, with a rich, dairy-like texture.

### Example 8

(A Canned Latte Comprising Traditional Coffee in Combination with Pumpkin Seed Milk is Produced)

The pumpkin seed milk of Example 2 (having a particle size distribution (PSD) of 1-3 μm) is added to cold-brewed coffee (2% solids) at a ratio of 1:1. Additionally, 0.1% dipotassium phosphate is added along with an amount of potassium hydroxide sufficient to bring the pH to 6.8. The mixture is filled into beverage cans with an amount of liquid nitrogen (LN2) sufficient to maintain can pressure, sealed and retorted to create a sterile product. The resulting beverage is rich, as if produced from dairy milk, but contains no dairy component.

### Example 9

(A Canned Latte Comprising a Coffee Substitute in Combination with Pumpkin Seed Milk was Produced)

The pumpkin seed milk of Example 2 was added to a coffee base made from non-coffee materials at a ratio of 1:1. 0.1% dipotassium phosphate was added as well as sufficient potassium hydroxide to bring the pH to 7.0. The mixture was filled into beverage cans with sufficient liquid nitrogen gas (LN2) to maintain can pressure, sealed and retorted to create a sterile product. The resulting beverage was rich like it was made from dairy milk with the roasted notes of coffee while containing no coffee, and no dairy component.

### Example 10

(A Non-Dairy Ice Cream Base was Prepared from a Pumpkin Seed Base Material)

The pumpkin seed milk of Example 2 (600 g) was combined with 60 g of water, and emulsified (using a rotor stator) with 55 g of medium chain triglyceride (MCT) oil and 15 g of avocado oil. To this emulsion, 40 g of inulin and 15 g of cornstarch were added with high shear. The mixture was brought to 85° C. for 3 minutes to hydrate the thickeners, then chilled to 15° C. Vanilla extract (10.5 g), salt (2 g) and granulated sugar (105 g) were added to the chilled mixture and fully incorporated using a rotor stator. Finally, 0.9 g of xanthan gum and 1.36 g of guar gum were added with high shear and mixed until fully hydrated. The mixture was chilled in an ice bath for 20 minutes and churned for 30 minutes to create a non-dairy pumpkin seed milk ice cream.

### Example 11

### (A Non-Dairy, Microparticulated Pumpkin Seed Whey is Prepared)

Filtered, β-glucanase-treated pumpkin seed milk base is prepared as described in Example 1, and then separated by centrifugation (e.g., 3000 RPM for 5 minutes, using a Elmi CM-76 Plus centrifuge). The aqueous phase, containing soluble and dispersed proteins, is then subjected to microparticulation with parameters sufficient to yield denatured protein particles (or particles comprising denatured protein) with PSD values in the range of 0.1-5 μm. Optionally, an amount of deamidase sufficient to modulate (e.g., incrementally increase, depending on the amount of deamidase used, and/or the contact time therewith) the thermal stability of the plant proteins may be included during at least part of the β-glucanase treatment. According to further aspects of the present invention, such incremental modulation of the thermal stability using deamidase, in combination with the subsequent microparticulation, provides for tailoring or fine-tuning of the properties of the whey.

### Example 12

### (A Non-Dairy, Microparticulated Pumpkin Seed Whey Milk, and Thermally Stable Whey Milk Latte is Prepared)

The microparticulated whey of Example 11 is adjusted to pH 7, then combined with sugar, salt, guar gum and gellan gum to create a low-fat, thermally stable, plant-based milk with the rich texture of dairy and high protein levels. This milk is then combined with a coffee extract (or with a non-coffee coffee substitute extract), filled into cans and retorted to produce a shelf stable, low-fat, high protein latte beverage with high thermal stability.

### Example 13

### (A Non-Dairy, Microparticulated Pumpkin Seed Whey Protein Additive is Prepared)

The microparticulated whey of Example 11 is concentrated using ultrafiltration, dried using spray drying, and then ground to produce a powder of fine denatured protein particles. This powder may be added to increase the protein of a low-protein plant-based milk (e.g., to enhance the protein content of almond milk), and/or to improve the texture of a plant-based milk (e.g., of almond milk) to better resemble the rich texture of dairy.

### Example 14

(A Non-Dairy, Particle Dispersion Prepared from Pumpkin Seeds is Used to Prepare a Non-Dairy Cheese Sauce)

The dispersed particles (e.g., including oil storage bodies) of the plant-based milk compositions prepared by the methods disclosed and exemplified herein, and having PSD values of 0.1-5 μm (preferably 1-3 μm), are isolated from the aqueous phase by decanting and centrifugation. They are then added to a non-dairy cheese sauce to add richness without adding butter or other animal fat.

### Example 15

### (A Non-Dairy Pumpkin Seed Cheese, or a Hybrid Cheese Including Dairy, is Prepared)

Particles (e.g., including oil storage bodies) of the plant-based milk compositions prepared by the methods disclosed and exemplified herein, and having PSD values of 0.1-5 μm (preferably 1-3 μm), are used in preparing a non-dairy cheese, or used in combination with dairy milk components to produce a hybrid cheese having reduced animal fat.

### Example 16

### (Enhanced Thermal Stability was Demonstrated by Comparing Denaturation Temperature Ranges of Deamidase-Treated Vs Untreated Pumpkin Seed Material)

Pumpkin seeds were treated identically to those in Example 3 through the fine grinding step. After completion of the grinding, the liquid and the grounds were separated by centrifuging.

The resulting liquid “whey” is decanted and split into two equal portions. One portion is refrigerated directly (4° C.), while the other is treated with glutamine deamidase (300 units/g; determined on the basis of half the original pumpkin seed mass) at pH 6 (e.g., adjusted with phosphoric acid) and 55° C. for 1 hour before adjusting the pH to 7 (e.g., with KOH) and chilling to 4° C.

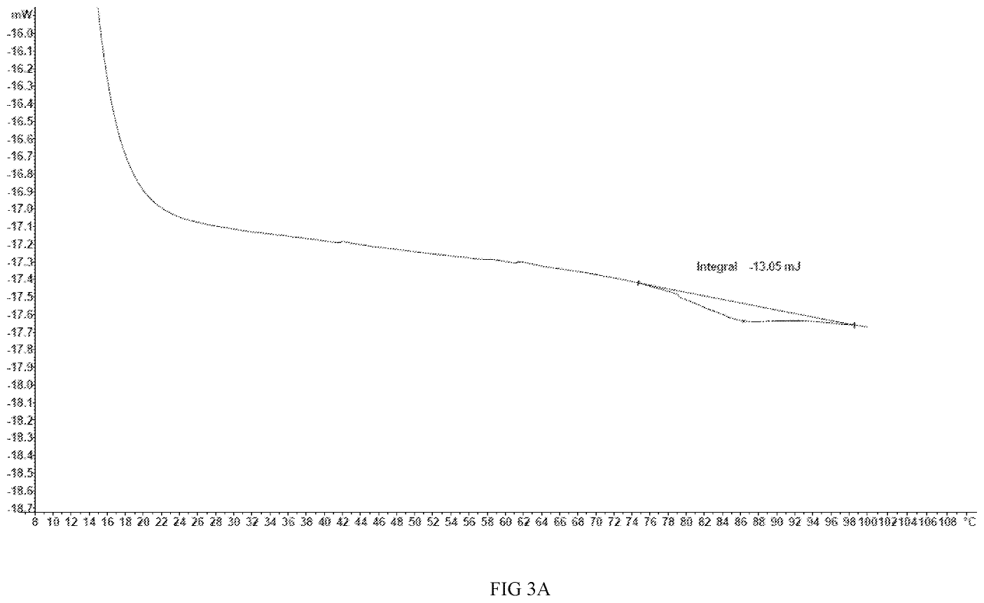

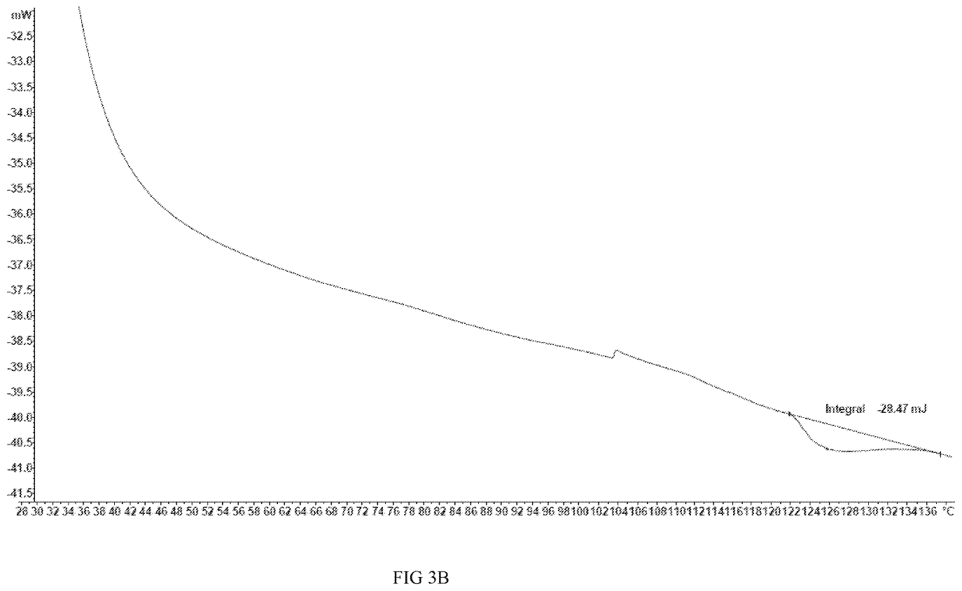

Ninety (90) μL aliquots of each sample were added to separate stainless steel medium pressure pans with FKM fluoroelastomer seals (Mettler Toledo). These samples were independently analyzed by differential scanning calorimetry, using a Mettler Toledo DSC3+. Samples were subjected to a 10° C./minute temperature ramp from 25 to 150° C. The resulting data are shown in FIGS. 3A (untreated) and 3B (glutamine deamidase-treated).

The data collected from the whey not treated by glutamine deamidase shows a broad coagulation peak with an onset around 75° C. and terminating around 100° C. The data collected from the whey treated by glutamine deamidase shows a sharper peak from 122-138° C.

The treatment with the glutamine deamidase enzyme resulted in an increase in denaturation temperatures of nearly 50° C., showing a significant improvement in the thermal stability of the plant-based protein due to the action of this enzyme.

The various methods and techniques described above provide a number of ways to carry out the invention. Of course, it is to be understood that not necessarily all objectives or advantages described can be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as taught or suggested herein. A variety of alternatives are mentioned herein. It is to be understood that some preferred embodiments specifically include one, another, or several features, while others specifically exclude one, another, or several features, while still others mitigate a particular feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be employed in various combinations by one of ordinary skill in this art to perform methods in accordance with the principles described herein. Among the various elements, features, and steps some will be specifically included and others specifically excluded in diverse embodiments.

Although the application has been disclosed in the context of certain embodiments and examples, it will be understood by those skilled in the art that the embodiments of the invention extend beyond the specifically disclosed embodiments to other alternative embodiments and/or uses and modifications and equivalents thereof.

In some embodiments, the numbers expressing quantities of ingredients, properties such as molecular weight, reaction conditions, and so forth, used to describe and claim certain embodiments of the application are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

In some embodiments, the terms “a” and “an” and “the” and similar references used in the context of describing a particular embodiment of the application (especially in the context of certain of the following claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application.

Preferred embodiments of this application are described herein. Variations on those preferred embodiments will become apparent to those of ordinary skill in the art upon reading the foregoing description. It is contemplated that skilled artisans can employ such variations as appropriate, and the application can be practiced otherwise than specifically described herein. Accordingly, many embodiments of this application include all modifications and equivalents of the subject matter recited in the claims appended hereto as permitted by applicable law. Moreover, any combination of the above-described elements in all possible variations thereof is encompassed by the application unless otherwise indicated herein or otherwise clearly contradicted by context.

All patents, patent applications, publications of patent applications, and other material, such as articles, books, specifications, publications, documents, things, and/or the like, referenced herein are hereby incorporated herein by this reference in their entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

The embodiments of the application disclosed herein are illustrative of the principles of the embodiments of the invention. Other modifications that can be employed can be within the scope of the application. Thus, by way of example, but not of limitation, alternative configurations of the embodiments of the application can be utilized in accordance with the teachings herein. Accordingly, embodiments of the present application are not limited to that precisely as shown and described.

1. A method for producing particles in a composition that replicate the texture of dairy milk or of a derivate thereof, comprising: contacting, under suitable solution reaction conditions, a plant-based base material having protein(s) and carbohydrate(s) with a β-glucanase (e.g., Ultimase from Novozymes) and/or a deamidase, in an amount and for a time-period sufficient to provide particles having a particle size distribution (PSD) in the range of 0.1 μm to 10 μm, provided that in the case of contacting with the β-glucanase, with or without the deamidase, particles are neither ground to 10 μm or less nor filtered through a 10 μm or less filter in achieving the PSD, and provided that in the case of contacting with the deamidase, with or without the β-glucanase, the thermal stability of the provided particles having the PSD is enhanced.

2. The method of claim 1, wherein contacting is sufficient to provide particles having a particle size distribution (PSD) in the range of 0.1 μm to 10 μm, provided that in the case of contacting with the β-glucanase, with or without the deamidase, particles are neither ground to 5 μm or less nor filtered through a 5 μm or less filter in achieving the PSD, and provided that in the case of contacting with the deamidase, with or without the β-glucanase, the thermal stability of the provided particles having the PSD is enhanced.

3. The method of claim 1, wherein contacting is sufficient to provide particles having a particle size distribution (PSD) in the range of 0.1 μm to 5 μm, provided that in the case of contacting with the β-glucanase, with or without the deamidase, particles are neither ground to 10 μm or less nor filtered through a 10 μm or less filter in achieving the PSD, and provided that in the case of contacting with the deamidase, with or without the β-glucanase, the thermal stability of the provided particles having the PSD is enhanced.

4. The method of claim 1, wherein contacting is sufficient to provide particles having a particle size distribution (PSD) in the range of 0.1 μm to 5 μm, provided that in the case of contacting with the β-glucanase, with or without the deamidase, particles are neither ground to 5 μm or less nor filtered through a 5 μm or less filter in achieving the PSD, and provided that in the case of contacting with the deamidase, with or without the β-glucanase, the thermal stability of the provided particles having the PSD is enhanced.

5. The method of any one of claims 1-4, wherein the PSD of the provided particles is in the range of 0.1 to less than 5 μm, 0.1 μm to 4 μm, 0.1 μm to 3 μm, 1.0 μm to less than 5 μm, 1.0 μm to 4 μm, or 1.0 μm to 3 μm.

6. The method of claim 5, wherein the PSD of the provided particles is in the range of 1.0 μm to 3 μm.

7. The method of any one of claims 1-6, wherein the provided particles having the PSD comprise β-glucanase cleavage products and/or deamidase cleavage products, and/or particles not having β-glucanase cleavage products and/or not having deamidase cleavage products, but which are released or otherwise rendered soluble by β-glucanase-mediated cleavage and/or by deamidase-mediated cleavage of another component(s) of the base material.

8. The method of any one of claims 1-7, wherein the provided particles having the PSD comprise protein, and/or carbohydrate, and/or lipid material.

9. The method of claim 8, wherein the lipid comprises one or more of fatty acids, glycerolipids, glycerophospholipids, sphingolipids, saccharolipids, polyketides, sterol lipids, prenol lipids, waxes, oils, oil storage bodies, sterols, fats, fat-soluble vitamins (e.g., A, D, E, and K), monoglycerides, diglycerides, triglycerides, and/or phospholipids.

10. The method of any one of claims 1-9, wherein contacting comprises contacting the base material with both the β-glucanase and the deamidase, either sequentially or at least in part contemporaneously.

11. The method of any one of claims 1-9, wherein contacting comprises contacting with the deamidase, but not the β-glucanase.

12. The method of any one of claims 1-11, wherein contacting with the β-glucanase, comprises contacting with about 0.01 to about 1000 units/g base material, with about 0.025 to about 50 units/g base material, with about 0.05 to about 50 units/g base material, with about 0.05 to about 10 units/g base material, or with about 0.1 to about 10 units/g base material; and/or wherein contacting with the deamidase(s) comprises contacting in an amount and for a time-period sufficient to deamidate amino acid side chains of protein(s) of the base material, and/or of the β-glucanase-treated base material, and or of the provided particles, to modify (preferably enhance) thermal stability thereof, relative to non-deamidated forms of the plant proteins, and provide a thermally stabilized texture.

13. The method of claim 12, wherein enhancing the thermal stability comprises increasing one or more of the denaturation onset temperature, the coagulation peak temperature, and/or the denaturation midpoint temperature, in each case by a value in the range of 5 to 75° C., 10 to 70° C., 15 to 65° C., 20 to 60° C., 30 to 55° C., 35 to 50° C., or in any subrange within 5 to 75° C.

14. The method of any one of claims 1-13, wherein, when contacting with the deamidase, the deamidase comprises glutamine deamidase and/or asparagine deamidase.

15. The method of claim 14, wherein contacting with the deamidase comprises: contacting with glutamine deamidase at about 0.01 to about 1000 units/g base material, at about 0.05 to about 75 units/g base material, or at: about 0.1 to about 15 units/g base material; and/or comprises contacting with asparagine deamidase at about 0.01 to about 1000 units/g base material, at about 0.05 to about 100 units/g base material, or at about 0.1 to about 30 units/g base material.

16. The method of any one of claims 1-9, wherein contacting comprises contacting with the β-glucanase, but not the deamidase, preferably wherein contacting with the β-glucanase, comprises contacting with about 0.01 to about 1000 units/g base material, with about 0.025 to about 50 units/g base material, with about 0.05 to about 50 units/g base material, with about 0.05 to about 10 units/g base material, or with about 0.1 to about 10 units/g base material.

17. The method of any one of claims 1-16, further comprising, after the contacting with the β-glucanase and/or the deamidase, centrifuging the solution to provide an aqueous supernatant phase (whey) containing soluble and dispersed proteins, and optionally subjecting the supernatant phase to microparticulation to provide a plant-based non-dairy microparticulated whey.

18. The method of any one of claims 1-16, further comprising one or more of washing or otherwise cleaning, blanching, parboiling, boiling, drying, grinding, denaturing, coagulating, sedimenting, centrifuging, concentrating, filtering, and/or microparticulating the base material, either prior to, during, or after the contacting with the β-glucanase and/or with the deamidase.

19. The method of claim 18, comprising centrifuging, or otherwise concentrating the provided particles having the PSD to provide an isolated particle concentrate suitable for use as a particle additive.

20. The method of claim 19, comprising use of the particle concentrate as, or as an additive for producing, a non-dairy plant-based milk, whey, half-and-half, cream, heavy cream, fermented product (e.g., yogurt, kefir, etc.), cheese, or powder; or use of the particle concentrate as an additive for producing a hybrid dairy, plant-based whey, milk, half-and-half, cream, heavy cream, fermented product (e.g., yogurt, kefir, etc.), cheese, or powder.

21. The method of claim 18, wherein drying the base material comprises adjusting the a_{w} comprises adjusting to a value less than or equal to a value selected from the group consisting of 0.95, 0.90, 0.85. 0.80, 0.75, 0.70, 0.65, 0.6, 0.55, 0.5, 0.45, 0.4, 0.35, 0.3, 0.25, 0.2, 0.15 and 0.1, or less than or equal to a value in a range of 0.10 to 0.95, including adjusting to a value less than or equal to any value in any subranges therein (e.g., 0.20 to 0.85, 0.25 to 0.80, 0.25 to 0.75, 0.25 to 0.70, 0.25 to 0.65, 0.25 to 0.60, 0.25 to 0.55), preferably to a value in a range of 0.25 to 0.70.

22. The methods of any one of claims 1-21, wherein plant-based base material comprises or is a natural and/or a processed and/or restructured plant material.

23. The method of any one of claims 1-22, wherein the plant-based material comprises one or more of: oil seeds; nuts; legumes; and/or grains.

24. The method of claim 23, wherein; the oil seeds comprise one or more of pumpkin seeds, sunflower seeds, watermelon seeds, flax, and/or hemp; the nuts comprise one or more of almonds, walnuts, cashews, macadamia, and/or hazelnuts; the legumes comprise one or more of peanuts, and/or peas; and the grains comprise one or more of wheat, oat, corn, rye, sorghum, rice, barley, millet, fonio, amaranth, quinoa, and or buckwheat.

25. The method of claim 24, wherein the oil seeds comprise pumpkin seeds.

26. A food or beverage component, comprising a PSD component prepared by the method of any one of claims 1-25.

27. The food or beverage component of claim 26, comprising or being a plant-based milk, plant-based milk, plant-based half-and-half, plant-based cream, plant-based heavy cream, plant-based fermented product (e.g., yogurt, kefir, etc.), plant-based milk powder, plant-based whey or derivative thereof, or plant-based cheese.

28. The food or beverage component of claim 27, comprising a combination of a dairy milk or component or derivative thereof with the plant-based milk, with the plant-based milk, plant-based half-and-half, plant-based cream, plant-based heavy cream, plant-based fermented product (e.g., yogurt, kefir, etc.), plant-based milk powder, plant-based whey or derivative thereof, or plant-based cheese.

29. A method for preparing a plant-based milk analog from a plant base material, comprising:
grinding a plant-based base material, wet or dry, to provide a PSD of less than 1 mm;
coagulating low heat stability proteins from an aqueous mixture of the ground base material;
filtering the coagulated mixture to remove the coagulated protein; and
treating the filtrate with a β-glucanase and/or a deamidase, in an amount and for a time-period sufficient to provide particles having a particle size distribution (PSD) in the range of 0.1 μm to 10 μm, provided that in the case of contacting with the β-glucanase, with or without the deamidase, particles are neither ground to 10 μm or less nor filtered through a 10 μm or less filter in achieving the PSD, and provided that in the case of contacting with the deamidase, with or without the β-glucanase, the thermal stability of the provided particles having the PSD is enhanced.

30. The method of claim 29, wherein contacting is sufficient to provide particles having a particle size distribution (PSD) in the range of 0.1 μm to 10 μm, provided that in the case of contacting with the β-glucanase, with or without the deamidase, particles are neither ground to 5 μm or less nor filtered through a 5 μm or less filter in achieving the PSD, and provided that in the case of contacting with the deamidase, with or without the β-glucanase, the thermal stability of the provided particles having the PSD is enhanced.

31. The method of claim 29, wherein contacting is sufficient to provide particles having a particle size distribution (PSD) in the range of 0.1 μm to 5 μm, provided that in the case of contacting with the β-glucanase, with or without the deamidase, particles are neither ground to 10 μm or less nor filtered through a 10 μm or less filter in achieving the PSD, and provided that in the case of contacting with the deamidase, with or without the β-glucanase, the thermal stability of the provided particles having the PSD is enhanced.

32. The method of claim 29, wherein contacting is sufficient to provide particles having a particle size distribution (PSD) in the range of 0.1 μm to 5 μm, provided that in the case of contacting with the β-glucanase, with or without the deamidase, particles are neither ground to 5 μm or less nor filtered through a 5 μm or less filter in achieving the PSD, and provided that in the case of contacting with the deamidase, with or without the β-glucanase, the thermal stability of the provided particles having the PSD is enhanced

33. The method of any one of claims 29-32, wherein the PSD of the provided particles is in the range of 0.1 to less than 5 μm, 0.1 μm to 4 μm, 0.1 μm to 3 μm, 1.0 μm to less than 5 μm, 1.0 μm to 4 μm, or 1.0 μm to 3 μm.

34. The method of claim 33, wherein the PSD of the provided particles is in the range of 1.0 μm to 3 μm.

35. The method of any one of claims 29-34, wherein the provided particles having the PSD comprise β-glucanase cleavage products and/or deamidase cleavage products, and/or particles not having β-glucanase cleavage products and/or not having deamidase cleavage products, but which are released or otherwise rendered soluble by β-glucanase-mediated cleavage and/or deamidase-mediated cleavage of another component(s) of the base material.

36. The method of any one of claims 29-35, wherein the provided particles having the PSD comprise protein, and/or carbohydrate, and/or lipid material.

37. The method of claim 36, wherein the lipid comprises one or more of fatty acids, glycerolipids, glycerophospholipids, sphingolipids, saccharolipids, and polyketides, sterol lipids, prenol lipids, waxes, oils, oil storage bodies, sterols, fats, fat-soluble vitamins (e.g., A, D, E, and K), monoglycerides, diglycerides, triglycerides, and/or phospholipids.

38. The method of any one of claims 29-37, wherein treating comprises treating the base material with both the β-glucanase and the deamidase, either sequentially or at least in part contemporaneously.

39. The method of any one of claims 29-37, wherein treating comprises contacting with the deamidase, but not the β-glucanase.

40. The method of any one of claims 29-39, wherein treating with the β-glucanase, comprises treating with about 0.01 to about 1000 units/g base material, with about 0.025 to about 50 units/g base material, with about 0.05 to about 50 units/g base material, with about 0.05 to about 10 units/g base material, or with about 0.1 to about 10 units/g base material; and/or wherein treating with the deamidase(s) comprises treating in an amount and for a time-period sufficient to deamidate amino acid side chains of protein(s) of the base material, and/or of the β-glucanase-treated base material, and or of the provided particles, to modify (preferably enhance) thermal stability thereof, relative to non-deamidated forms of the plant proteins, and provide a thermally stabilized texture.

41. The method of claim 40, wherein enhancing the thermal stability comprises increasing one or more of the denaturation onset temperature, the coagulation peak temperature, and/or the denaturation midpoint temperature, in each case by a value in the range of 5 to 75° C., 10 to 70° C., 15 to 65° C., 20 to 60° C., 30 to 55° C., 35 to 50° C., or in any subrange within 5 to 75° C.

42. The method of any one of claims 29-41, wherein, in the case of treating with the deamidase, the deamidase comprises glutamine deamidase and/or asparagine deamidase.

43. The method of claim 42, wherein contacting with the deamidase comprises: contacting with glutamine deamidase at about 0.01 to about 1000 units/g base material, at about 0.05 to about 75 units/g base material, or at: about 0.1 to about 15 units/g base material; and/or comprises contacting with asparagine deamidase at about 0.01 to about 1000 units/g base material, at about 0.05 to about 100 units/g base material, or at about 0.1 to about 30 units/g base material.

44. The method of any one of claims 29-37, wherein contacting comprises contacting with the β-glucanase, but not the deamidase, preferably wherein contacting with the β-glucanase, comprises contacting with about 0.01 to about 1000 units/g base material, with about 0.025 to about 50 units/g base material, with about 0.05 to about 50 units/g base material, with about 0.05 to about 10 units/g base material, or with about 0.1 to about 10 units/g base material.

45. The method of any one of claims 29-44, comprising, prior to the grinding of the plant-based base material, wet or dry, to provide the PSD of less than 1 mm, heating the base material in an aqueous medium (e.g., alkaline aqueous medium), optionally followed by draining and/or rinsing.

46. The method of claim 45, wherein the base material is dried prior to the grinding.

47. The method of any one of claims 29-46, wherein coagulating the low heat stability proteins from the aqueous mixture of the ground base material, and the filtering thereof comprise bringing the ground base material in the aqueous mixture to at least 65° C. for 5 minutes before filtering using a 25 μm filter.

48. The method of any one of claims 29-47, further comprising, after the contacting with the β-glucanase and/or the deamidase, centrifuging the solution to provide an aqueous supernatant phase (whey) containing soluble and dispersed proteins, and optionally subjecting the supernatant phase to microparticulation to provide a plant-based non-dairy microparticulated whey.

49. The method of any one of claims 29-47, further comprising one or more of washing or otherwise cleaning, blanching, parboiling, boiling, drying, grinding, denaturing, coagulating, sedimenting, centrifuging, concentrating, filtering, and/or microparticulating the base material, either prior to, during, or after the contacting with the β-glucanase and/or with the deamidase

50. The method of claim 49, comprising centrifuging, or otherwise concentrating the provided particles having the PSD to provide an isolated particle concentrate suitable for use as a particle additive.

51. The method of claim 50, comprising use of the particle concentrate as, or as an additive for producing, a non-dairy plant-based milk, whey, half-and-half, cream, heavy cream, fermented product (e.g., yogurt, kefir, etc.), cheese, or powder; or use of the particle concentrate as an additive for producing a hybrid dairy, plant-based whey, milk, half-and-half, cream, heavy cream, fermented product (e.g., yogurt, kefir, etc.), cheese, or powder.

52. The method of claim 49, wherein drying the base material comprises adjusting the a_{w} to a value less than or equal to a value selected from the group consisting of 0.95, 0.90, 0.85. 0.80, 0.75, 0.70, 0.65, 0.6, 0.55, 0.5, 0.45, 0.4, 0.35, 0.3, 0.25, 0.2, 0.15 and 0.1, or less than or equal to a value in a range of 0.10 to 0.95, including adjusting to a value less than or equal to any value in any subranges therein (e.g., 0.20 to 0.85, 0.25 to 0.80, 0.25 to 0.75, 0.25 to 0.70, 0.25 to 0.65, 0.25 to 0.60, 0.25 to 0.55), preferably to a value in a range of 0.25 to 0.70.

53. The methods of any one of claims 29-52, wherein plant-based base material comprises or is a natural and/or a processed and/or restructured plant material.

54. The method of any one of claims 29-53, wherein the plant-based material comprises one or more of: oil seeds; nuts; legumes; and/or grains.

55. The method of claim 54, wherein; the oil seeds comprise one or more of pumpkin seeds, sunflower seeds, watermelon seeds, flax, and/or hemp; the nuts comprise one or more of almonds, walnuts, cashews, macadamia, and/or hazelnuts; the legumes comprise one or more of peanuts, and/or peas; and the grains comprise one or more of wheat, oat, corn, rye, sorghum, rice, barley, millet, fonio, amaranth, quinoa, and or buckwheat.

56. The method of claim 55, wherein the oil seeds comprise pumpkin seeds.

57. A food or beverage component, comprising a PSD component prepared by the method of any one of claims 29-56.

58. The food or beverage component of claim 57, comprising or being a plant-based milk, plant-based half-and-half, plant-based cream, plant-based heavy cream, plant-based fermented product (e.g., yogurt, kefir, etc.), plant-based milk powder, plant-based whey or derivatives thereof, or plant-based cheese.

59. The food or beverage component of claim 58, comprising a combination of a dairy milk or a component or derivative thereof with the plant-based milk, plant-based half-and-half, plant-based cream, plant-based heavy cream, plant-based fermented product (e.g., yogurt, kefir, etc.), plant-based milk powder, plant-based whey or derivatives thereof, or plant-based cheese.

60. A non-dairy composition that replicates the texture of dairy milk or of a derivate thereof, comprising an enzymatically-treated plant-based material having deamidated plant protein(s), and/or β-glucanase-cleaved plant carbohydrate(s), the composition having a D90 particle size distribution (PSD) value in the range of 0.1 μm to 10 μm.

61. The composition of claim 60, wherein the D90 PSD of the plant-based particles is in the range of 0.1 μm to 5 μm.

62. The composition of claim 61, wherein the D90 PSD of the plant-based particles is in the range of 0.1 μm to less than 5 μm, 0.1 μm to 4 μm, 0.1 μm to 3 μm, 1.0 μm to less than 5 μm, 1.0 μm to 4 μm, or 1.0 μm to 3 μm.

63. The composition of claim 62, wherein the D90 PSD of the plant-based particles is in the range of 1.0 μm to 3 μm.

64. The composition of any one of claims 60-63, wherein the particles having the PSD comprise protein, and/or carbohydrate, and/or lipid material.

65. The composition of claim 64, wherein the lipid comprises one or more of fatty acids, glycerolipids, glycerophospholipids, sphingolipids, saccharolipids, polyketides, sterol lipids, prenol lipids, waxes, oils, oil storage bodies, sterols, fats, fat-soluble vitamins (e.g., A, D, E, and K), monoglycerides, diglycerides, triglycerides, and/or phospholipids.

66. The composition of any one of claims 60-65, wherein the particles having the PSD comprise both deamidated plant protein(s) and β-glucanase-cleaved plant carbohydrate(s).

67. The composition of any one of claims 60-66, wherein the particles having the PSD comprise deamidated plant protein(s), but not β-glucanase-cleaved plant carbohydrate(s).

68. The composition of any one of claims 60-67, wherein, when deamidated plant protein(s) comprises glutamine-deamidated plant proteins and/or asparagine-deamidated plant proteins.

69. The composition of any one of claims 60-68, wherein the amount of deamidated plant protein(s) in the particles having the PSD is sufficient to modify (preferably enhance) thermal stability thereof relative to non-deamidated forms of the plant proteins, and provide for a thermally stabilized texture.

70. The composition of claim 69, wherein relative to the non-deamidated plant protein, a coagulation peak, or denaturation midpoint of the deamidated plant protein in aqueous solution is increased by a value in the range of 5 to 75° C., 10 to 70° C., 15 to 65° C., 20 to 60° C., 30 to 55° C., 35 to 50° C., or in any subrange within 5 to 75° C.

71. The composition of any one of claims 60-65, wherein the particles having the PSD comprise β-glucanase-cleaved plant carbohydrate(s), but not deamidated plant protein(s).

72. The composition of any one of claims 60-71, wherein the composition is a constituent of a plant-based non-dairy whey.

73. The composition of any one of claims 58-69, wherein the composition comprises or is an isolated particle concentrate suitable for use as a particle additive.

74. The composition of claim 73, wherein the composition is a constituent of: a non-dairy plant-based milk, whey, half-and-half, cream, heavy cream, fermented product (e.g., yogurt, kefir, etc.), cheese, or powder; or of a hybrid dairy, plant-based whey, milk, half-and-half, cream, heavy cream, fermented product, cheese, yogurt, or powder.

75. The composition of claim 74, wherein a_{w} of the powder is adjusted to a value less than or equal to a value selected from the group consisting of 0.95, 0.90, 0.85. 0.80, 0.75, 0.70, 0.65, 0.6, 0.55, 0.5, 0.45, 0.4, 0.35, 0.3, 0.25, 0.2, 0.15 and 0.1, or less than or equal to a value in a range of 0.10 to 0.95, including to a value less than or equal to any value in any subranges therein (e.g., 0.20 to 0.85, 0.25 to 0.80, 0.25 to 0.75, 0.25 to 0.70, 0.25 to 0.65, 0.25 to 0.60, 0.25 to 0.55), preferably to a value in a range of 0.25 to 0.70.

76. The composition of any one of claims 60-75, wherein plant-based base material comprises or is a natural and/or a processed and/or restructured plant material.

77. The composition of any one of claims 60-76, wherein the plant-based material comprises one or more of: oil seeds; nuts; legumes; and/or grains.

78. The composition of claim 77, wherein; the oil seeds comprise one or more of pumpkin seeds, sunflower seeds, watermelon seeds, flax, and/or hemp; the nuts comprise one or more of almonds, walnuts, cashews, macadamia, and/or hazelnuts; the legumes comprise one or more of peanuts, and/or peas; and the grains comprise one or more of wheat, oat, corn, rye, sorghum, rice, barley, millet, fonio, amaranth, quinoa, and or buckwheat.

79. The composition of claim 78, wherein the oil seeds comprise pumpkin seeds.
